(19) United States
(12) Patent Application Publication
(10) Pub. No.: US 2014/0092347 A1
(43) Pub. Date: Apr. 3, 2014

(54) LIQUID CRYSTAL DISPLAY PANEL AND LIQUID CRYSTAL DISPLAY DEVICE

(71) Applicants: Eiji Satoh, Osaka-shi (JP); Akio Miyata, Osaka-shi (JP); Kazuhiro Deguchi, Osaka-shi (JP)

(72) Inventors: Eiji Satoh, Osaka-shi (JP); Akio Miyata, Osaka-shi (JP); Kazuhiro Deguchi, Osaka-shi (JP)

(73) Assignee: SHARP KABUSHIKI KAISHA, Osaka-shi, Osaka (JP)

(21) Appl. No.: 14/116,829

(22) PCT Filed: Jun. 27, 2012
(86) PCT No.: PCT/JP2012/066441

§ 371 Date: Nov. 11, 2013

(30) Foreign Application Priority Data
Sep. 1, 2011 (JP) 2011-191111

(51) Int. Cl. G02F 1/1335

(52) U.S. Cl. CPC G02F 1/133536; G02F 1/133514; G02F 1/133553
USPC 349/96; 349/106

(57) ABSTRACT

A variable reflectance mirror (5) is arranged between a liquid crystal layer (4) and a CF layer (6) in a liquid crystal display panel (1). In reflective-type display, because incident light is reflected by the variable reflectance mirror (5) before reaching the CF layer (6), light absorption due to the CF layer (6) does not occur.

### TECHNICAL FIELD

The present invention relates to a liquid crystal display panel and a liquid crystal display device including the liquid crystal display panel.

### BACKGROUND ART

Liquid crystal display devices have the advantages of having low power consumption and being thin and light compared to the other display devices such as the CRT display devices and plasma display devices.

There are currently three types of displays in liquid crystal display devices, a transmissive-type display, a reflective-type display, and a hybrid-type display having both characteristics of the reflective-type display and the transmissive-type display. The hybrid-type display is also called a transflective-type display. Among these, since the transmissive-type display normally performs with a backlight as a light source, in a bright light condition, it is difficult for a user to recognize brightness of the backlight passing through pixels. On the other hand, since the reflective-type display performs using external light such as ambient light, in a dark condition, it is difficult to display a vivid image due to insufficient of the amount of light emitted from the light source.

In contrast, the hybrid-type display includes both characteristics of the transmissive-type display and the reflective-type display. The hybrid-type display switches between reflective-type display that uses external light and transmissive-type display that uses a backlight, for example, according to the brightness of the external light. Through such switching, it is expected that high-definition display can be performed in various light environments.

FIG. 13 is an explanatory diagram showing the arrangement of a transparent region in one pixel for each type in earlier liquid crystal display devices of the related art. In such hybrid-type display devices, a reflective portion 42 and a transmissive portion 43 are provided in one pixel 41, as shown in FIG. 13(a). Therefore, the aperture ratio of the transmissive portion 43 in the pixel 41 of the hybrid-type display device is smaller than that of the transmissive-type display device (FIG. 13(b)). Accordingly, there is a problem in that a display as bright as the transmissive-type display device is not obtained when the hybrid-type display device is used as a transmissive-type.

In addition, when the hybrid-type display device is used as a reflective-type, because the area ratio of the reflective portion in the pixel is smaller than that in a reflective-type display device, there is also a problem in that a display as bright as the reflective-type display device is not obtained.

In order to solve these problems, the following technologies have been developed for a hybrid-type display device.

For example, a liquid crystal display device in PTL 1, as shown in FIG. 14, includes a liquid crystal panel 51, a backlight 52, and an electrochemical element 53 provided between the liquid crystal panel 51 and the backlight 52. The electrochemical element 53 controls the reflectance of external light incident through the liquid crystal panel 51 or the transmissivity of light emitted from the backlight 52 by changing the precipitation amount of metal included in an electrolyte solution on a transparent electrode.

In addition, because a counter electrode opposing the transparent electrode configuring the electrochemical element 53 is formed by fine lines, the liquid crystal panel 51 is able to be irradiated without blocking light from the backlight 52, and a large aperture ratio is obtained. Therefore, even in a case of a reflective-type display using external light, or in a case of a transmissive-type display using a backlight, a bright screen display may be obtained compared to a hybrid-type display device at the early stages. In addition, during reflective-type display operation, it is possible to realize low power consumption because the backlight does not have to be used.

In PTL 2, a transmission and reflection-type switching liquid crystal display using a polymer dispersion-type liquid crystal is disclosed. The characteristic thereof is switching between a transparent state and a reflective state by changing the arrangement of the liquid crystal in a liquid crystal region to an ordered state or a random state.

In PTL 3, a liquid crystal display device using a minute electromechanical reflective-type array is disclosed. The characteristic thereof is switching between a reflective state and a transparent state by moving the position of the minute electromechanical reflective-type array between substantially horizontal and perpendicular with respect to a liquid crystal display surface.

All of PTL 1, PTL 2, and PTL 3 realize a large aperture ratio by including an element in which the reflectance is changed by a voltage applied from the outside, and controlling the reflective state and the transmissive state.

### CITATION LIST

### Patent Literature

PTL 1: Japanese Unexamined Patent Application Publication No. 10-253948 (Sep. 25, 1998)
PTL 2: Japanese Unexamined Patent Application Publication No. 2004-021254 (Jan. 22, 2004)
PTL 3: Japanese Unexamined Patent Application Publication (Translation of PCT Application) No. 2007-510181 (Apr. 19, 2007)

### Non Patent Literature

NPL 1: Yoshimura, Kazuki “Development of Switchable Mirror Glass with High Energy Efficiency” (Applied Physics, The Japan Society of Applied Physics, Volume 79, Issue 7, published 10 Jul. 2010, pp. 628 to 632)

### SUMMARY OF INVENTION

### Technical Problem

However, in the technology disclosed in PTL 1, as shown in FIG. 14, because the electrochemical element 53 is placed on the rear face (backlight 52 side) of the substrate configuring the liquid crystal panel 51, there is a problem in that parallax occurs during reflective display operation due to the thickness of the substrate.

In addition, in order to reduce the parallax, it is necessary for the reflective surface to be a flat mirror surface. This is because when irregular reflection occurs on the reflective surface, reflected light from the display surface, which causes parallax by generating oblique emission, increases.

In this way, in a case where reflective-type display is performed by the liquid crystal display device of PTL 1, satisfactory display is obtained only in the specular reflection direction in an environment with a point light source or the like.

Furthermore, in a case where reflective-type display is performed by the liquid crystal display device of PTL 1, light reciprocates in the liquid crystal panel 51 including two polarization plates and a color filter. At this time, the light passes through the two polarization plates a total of four times, and passes through the color filter a total of two times. Therefore, during the reflective-type display operation, there is a problem in that a brighter display than that during the transmissive-type display operation is not obtained because the intensity of light is significantly attenuated.

The present invention is made in consideration of the above-described problems, and it is desirable to provide a liquid crystal display panel and a liquid crystal display device able to perform satisfactory reflective-type display with a liquid crystal display panel and a liquid crystal display device switchable between transmissive-type display and reflective-type display.

### Solution to Problem

According to an embodiment of the present invention, there is provided a liquid crystal display panel including (a) a liquid crystal layer; (b) a color filter layer; (c) a variable reflectance layer that is arranged between the liquid crystal layer and the color filter layer and changes the reflectance of light by external control, in which, (d) the liquid crystal display panel switches between transmissive-type display in which a path of light is a path passing through the liquid crystal layer in one direction and reflective-type display in which a path of light is a path in which light directed at the variable reflectance layer from the liquid crystal layer is reflected on the variable reflectance layer according to control of reflectance of the variable reflectance layer.

According to the configuration, by changing the reflectance of the variable reflectance layer through control from the outside, the variable reflectance layer may be in a transmissive state suitable for transmissive-type display or in a reflective state suitable for reflective-type display.

In a case where reflective-type display is performed, light traveling from the liquid crystal layer toward the variable reflectance layer is reflected by the variable reflectance layer before reaching the color filter layer. Accordingly, the problem of the intensity of light being attenuated by the color filter layer does not occur. Since the light does not transit the color filter layer, although the reflective-type display becomes black and white display, a bright reflective-type display may be performed.

In addition, in a case where full color display is performed using the color filter layer, it is necessary that a single pixel be configured of, for example, three sub-pixels of red, green, and blue. In contrast, in the configuration, since it is possible to use one of the sub-pixels as the smallest pixel in black and white display, it is possible to perform high-definition black and white display with three times the resolution compared to full color display in which one pixel is configured by 3 sub-pixels. Accordingly, the reflective-type display of the present invention is suitable to uses displaying primarily fine characters.

Furthermore, in a case where the liquid crystal display device according to PTL 1 in which an electrochemical element is provided between a liquid crystal panel and a backlight performs reflective-type display operation, if the light does not pass through the display surface of the liquid crystal panel and a substrate and the polarization plate provided on the rear surface side of the opposite side, the light does not reach the electrochemical element. In contrast, in the case of the present invention, since light does not pass through the display surface of the liquid crystal display panel and a substrate and the polarization plate provided on the rear surface side of the opposite side, the attenuation of the intensity of light is suppressed, and the occurrence of parallax is suppressed.

In so doing, according to the present invention, there is provided a liquid crystal display panel that can perform satisfactory reflective-type display.

A liquid crystal display device including the liquid crystal display panel and a light source for transmissive-type display falls into the category of the present invention. The liquid crystal display device is suitable to applications using satisfactory reflective-type display and satisfactory transmissive-type display, respectively, according to the environmental illuminance.

### Advantageous Effects of Invention

The liquid crystal display panel and the liquid crystal display device according to the present invention include a variable reflectance layer changing the reflectance thereof by control from the outside between the liquid crystal layer and the color filter layer.

Therefore, a hybrid-type display device that uses both reflective-type display and transmissive-type display, according to environmental illuminance, exhibits an effect that the quality of reflective-type display can be improved.

### BRIEF DESCRIPTION OF DRAWINGS

FIG. 1(a) is a schematic diagram showing a laminated configuration example of a liquid crystal display panel according to an embodiment of the present invention in a state of reflective-type display. FIG. 1(b) is a schematic diagram showing a laminated configuration example of a liquid crystal display panel according to an embodiment of the present invention in a state of transmissive-type display.

FIG. 2 is an explanatory diagram schematically showing a comparison of the brightness in reflective-type display between a liquid crystal display panel according to the present embodiment and a liquid crystal display panel of the related art.

FIG. 3 is a diagram schematically describing various optically functional layers configuring a liquid crystal display panel including a VA mode liquid crystal layer.

FIG. 4 is a diagram showing a modification example of a configuration shown in FIG. 3.

FIG. 5 is a diagram schematically describing various optically functional layers configuring a liquid crystal display panel including an IPS mode liquid crystal layer.

FIG. 6 is a diagram showing a modification example of a configuration shown in FIG. 5.

FIG. 7 is a diagram schematically describing a configuration of a liquid crystal display panel including an in-cell polarization plate.

FIG. 8 is a configuration diagram showing the main parts of a configuration of a liquid crystal display panel according to an embodiment of the present invention, including a variable reflectance mirror of the related art configured by a multi-layer film.

FIG. 9 is a configuration diagram showing a modification example of a variable reflectance mirror.

FIG. 10(a) is a schematic diagram showing a laminated configuration example of a liquid crystal display panel according to an embodiment of the present invention in a state of reflective-type display. FIG. 10(b) is a schematic diagram showing a laminated configuration example of a liquid crystal display panel according to an embodiment of the present invention in a state of transmissive-type display.

FIG. 11(a) is an explanatory diagram schematically showing a configuration of a variable reflectance mirror functioning as a wire grid polarizer. FIG. 11(b) is an explanatory diagram showing an enlarged portion of the configuration in FIG. 11(a).

FIG. 12 is a diagram schematically describing a configuration of a liquid crystal display panel including the variable reflectance mirror shown in FIG. 11.

FIG. 13 is an explanatory diagram showing the arrangement of a transparent region in one pixel for each type in a liquid crystal display device of the related art.

FIG. 14 is an explanatory diagram showing a configuration of a liquid crystal display device of the related art of a hybrid-type.

### DESCRIPTION OF EMBODIMENTS

Hereinafter, embodiments of the present invention will be described in detail. Moreover, as long as not specifically described, the measurements, materials, and shapes of configuration components disclosed in the embodiments and the relative arrangements thereof or the like are merely simple examples, and the scope of the invention is not limited to the gist thereof.

### Embodiment 1

### (Basic Configuration of Liquid Crystal Display Panel)

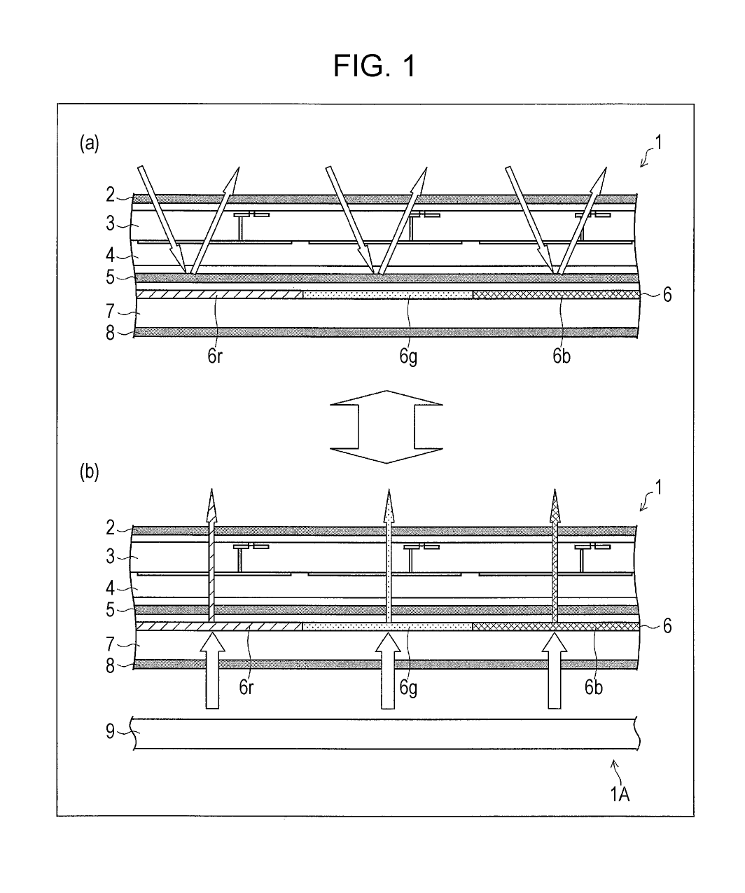

FIG. 1(a) is a schematic diagram showing a laminated configuration example of a liquid crystal display panel 1 according to an embodiment of the present invention in a state of reflective-type display. FIG. 1(b) is a schematic diagram showing a laminated configuration example of a liquid crystal display panel 1 according to an embodiment of the present invention in a state of transmissive-type display.

As shown in FIG. 1, the liquid crystal display panel 1 includes a first circular polarization plate 2, a TFT substrate 3, a liquid crystal layer 4, a variable reflectance mirror (variable reflectance layer) 5, a color filter (below, referred to as CF for short) layer 6, a CF substrate 7, and a second circular polarization plate 8 which are arranged in order from an observer side.

The variable reflectance mirror 5 is able to switch between a reflective state with a reflectance of 50% or higher, and preferably 90% or higher and a transparent state with a reflectance of lower than 50%, and preferably 20% or lower.

Moreover, as described later, in a case where the liquid crystal display panel 1 performs the reflective-type display, the liquid crystal display panel is basically set to normally black. However, in a configuration including an in-cell type polarization plate, the panel is also compatible with a normally white reflective-type display. Meanwhile, in a case where the liquid crystal display panel 1 performs the transmissive-type display, the panel is compatible with either of normally black and normally white modes.

However, a case where a normally white transmissive-type display is employed is preferable since higher contrast is obtained as the reflectance of the variable reflectance mirror 5 approaches 0% (that is, a completely transparent state). Furthermore, it is most preferable that the variable reflectance mirror 5 be able to switch between a state reflecting completely and a state transmitting completely, since the display quality can be improved in either of the normally black and normally white modes.

In addition, along with the liquid crystal display panel 1, a backlight 9 configuring a liquid crystal display device 1A (FIG. 1(b)) is arranged opposing the second circular polarization plate 8.

(Effects Due to Characteristic Arrangement of Variable Reflectance Mirror)

The variable reflectance mirror 5, as described in detail later, that can change the reflectance of light according to control from outside of the liquid crystal display panel 1. In so doing, in a state in which the reflectance of the variable reflectance mirror 5 is increased, the liquid crystal display panel 1 is able to perform reflective-type display shown in FIG. 1(a). Meanwhile, in a state in which the reflectance of the variable reflectance mirror 5 is lowered, the liquid crystal display panel 1 is able to perform the transmissive-type display shown in FIG. 1(b).

More specifically, in a case where reflective-type display is performed, light which is incident from the first circular polarization plate 2 and passes through the liquid crystal layer 4 (environmental light) is reflected by the variable reflectance mirror 5, and returns to the first circular polarization plate 2 by passing through the liquid crystal layer 4 again.

Accordingly, because the variable reflectance mirror 5 is arranged between the liquid crystal layer 4 and the CF layer 6, in a case where reflective-type display is performed, light is reflected by the variable reflectance mirror 5 without passing through the CF layer 6 and the CF substrate 7. As a result, a problem in which the intensity of light is attenuated by the CF layer 6 and the CF substrate 7 does not occur. In addition, it is possible to prevent the occurrence of parallax due to the thickness of the CF substrate 7.

Furthermore, when considering the number of times passing through the polarization plate with a strong influence by which the intensity of light is attenuated, in the liquid crystal display panel 1, the number of times passing through the first circular polarization plate 2 is two.

As a result, a bright reflective-type display is obtained. Moreover, in a case where reflective-type display is performed, because light does not pass through the CF layer 6, the intensity of light may not be modulated according to the wavelength region. Accordingly, the reflective-type display becomes a black and white gradation display.

However, since it is possible to use, for example, one of the three red, green and blue sub-pixels 6r, 6g, and 6b (FIG. 1(a)) configuring one pixel as the smallest pixel of black and white display, it is possible to perform high definition black and white display at three times the resolution compared to full color display in which one pixel is configured by three sub-pixels. Accordingly, the reflective-type display of the liquid crystal display panel 1 is suitable to uses such as an electronic book displaying mainly fine text.

Moreover, in order to reduce reflected light to the observer side through wiring provided in the liquid crystal display panel 1, a low reflection film, such as low reflection chromium or nickel alloy, may be partially provided between the wiring and the TFT substrate 3 (substrate provided with wiring) or the first circular polarization plate 2 (display surface side polarization plate). This point holds true for all of the substitution example and modification examples of the liquid crystal display panel described later.

(Overview of Transmissive-Type Display)

In a case where the liquid crystal display panel 1 performs reflective-type display, the backlight 9 is turned off. In contrast, in a case where the liquid crystal display panel 1 performs transmissive-type display, the backlight 9 is used as a light source. Moreover, a backlight such as a direct-type or side-edge type may be employed as the backlight 9, without being limited to these forms.

As shown in FIG. 1(b), light emitted by the backlight 9 is incident on the second circular polarization plate 8, reaches the first circular polarization plate 2 by passing through the CF layer 6 and each layer including the variable reflectance mirror 5 controlled to a low reflectance. In the transmissive-type display, the intensity of light in the corresponding wavelength regions is modulated by the respective three red, green, and blue sub-pixels 6r, 6g, and 6b, and full color display is performed.

Accordingly, the transmissive-type display of the liquid crystal display panel 1 is suitable to uses of a tablet computer, such as color display of various images and moving images and browsing various web pages via the Internet.

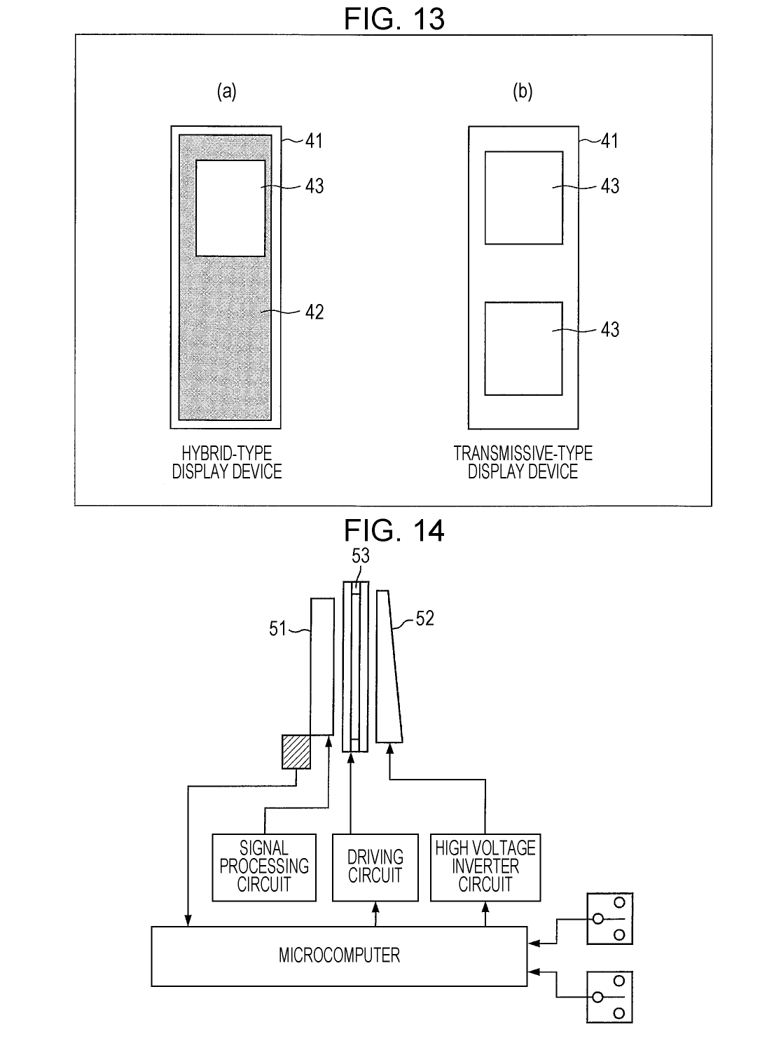

Moreover, as in an initial hybrid-type liquid crystal display device shown in FIG. 13(a), in the liquid crystal display panel 1, all portions of a pixel other than the wiring become transparent, and it is possible to obtain a much brighter transmissive-type display because the transparent aperture ratio increases when compared to a configuration in which a reflective portion and a transmissive portion are formed in one pixel.

### COMPARATIVE EXAMPLE

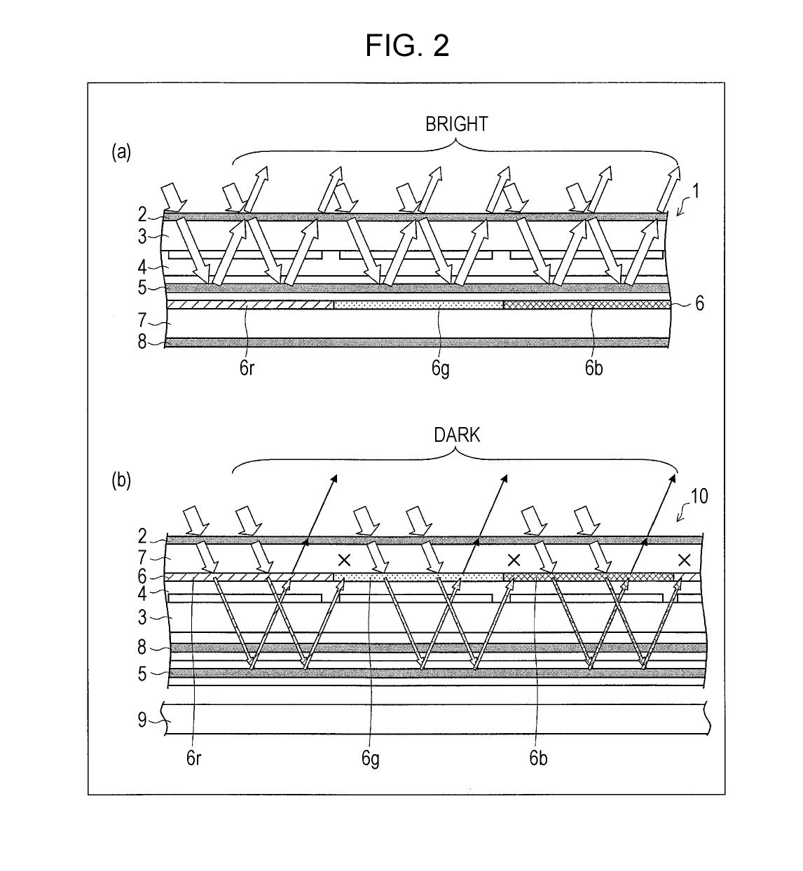

FIG. 2 is an explanatory diagram schematically showing a comparison of the brightness in reflective-type display with a liquid crystal display panel 1 according to the present embodiment and a liquid crystal display panel 10 of the related art.

As shown in FIG. 2(b), the liquid crystal display panel 10 of the comparative example includes a first circular polarization plate 2, a CF substrate 7, a CF layer 6, a liquid crystal layer 4, a TFT substrate 3, a second circular polarization plate 8, and a variable reflectance mirror 5 which are arranged in order from an observer side.

In a case where the liquid crystal display panel 10 performs reflective-type display, light incident from the first circular polarization plate 2 reaches the variable reflectance mirror 5 by passing through the CF substrate 7, the CF layer 6, the liquid crystal layer 4, the TFT substrate 3 and the second circular polarization plate 8. The light reflected by the variable reflectance mirror 5 returns to the first circular polarization plate 2 by following the reverse path.

Accordingly, when considering the number of passing through the polarization plate and the CF layer with a strong influence by which the intensity of light is attenuated, the number of times passing through the polarization plate becomes four, and the number of times passing through the CF layer becomes two. In addition, for example, a portion of the red light selected by wavelength by the red CF layer 6 is incident on the green or blue CF layer 6 and absorbed after being reflected by the variable reflectance mirror 5.

In this way, the reflective-type display of the liquid crystal display panel 10 becomes a dark display because there are many factors attenuating the intensity of light. In addition, because of passing through the TFT substrate 3 and the CF substrate 7, the problem of parallax caused by the thickness of the substrate becomes remarkable.

In contrast, in the transmissive-type display of the liquid crystal display panel 1, the amount of light based on the content already described is expressed by the thickness and number of the white arrows in FIG. 2(a), the display becomes bright and the occurrence of parallax is suppressed.

### Form Example 1 of Liquid Crystal Display Panel

### Reflective and Transmissive NB Mode

The specific configuration according to the liquid crystal display panel 1 according to the present embodiment changes according to what sort of operating mode of the liquid crystal layer the liquid crystal layer 4 is set to, and, in a case where transmissive-type display is performed, which of either of the normally black and normally white modes are employed. Moreover, as described above, in a case where the liquid crystal display panel 1 performs reflective-type display, the liquid crystal display panel is basically set to normally black.

First of all, a case will be described in which a Vertical Alignment (VA) mode liquid crystal layer is applied to the liquid crystal layer 4, and both of the reflective-type display and transmissive-type display are set to normally black. In the VA mode, the liquid crystal layer 4 is configured by an n-type liquid crystal vertically aligned with respect to the display surface of the liquid crystal display panel 1, as one example.

Moreover, in the description below, the normally black mode and the normally white mode are referred to as the NB mode and the NW mode for short. In addition, a display mode in which the NB mode is employed by both of the reflective-type display and the transmissive-type display is referred to as a reflective and transmissive NB mode for short, and a display mode in which the NW mode is employed by the reflective-type display and the transmissive-type display is referred to as a reflective and transmissive NW mode for short. In addition, a display mode in which the NB mode is employed by the reflective-type display and the NW mode is employed by the transmissive-type display is referred to as a reflective NB/transmissive NW mode for short. Furthermore, an NB mode reflective-type display, NB mode transmissive-type display, NW mode reflective-type display, and NW mode transmissive-type display are respectively referred to as a reflective NB mode, transmissive NB mode, reflective NW mode and transmissive NW mode for short.

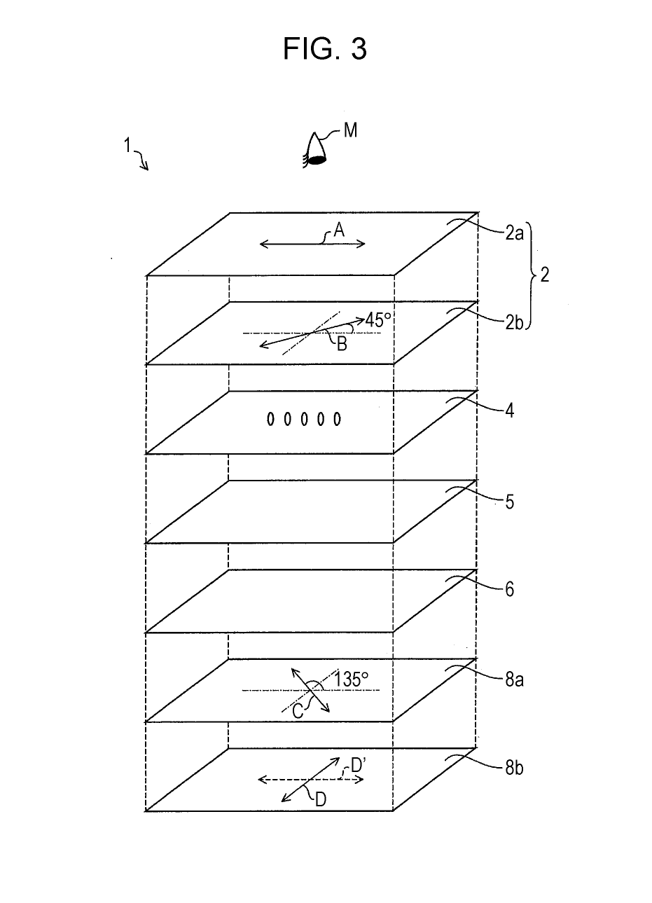

FIG. 3 is a diagram schematically describing various optically functional layers configuring a reflective and transmissive display NB mode liquid crystal display panel 1 including a VA mode liquid crystal layer 4.

As shown in FIG. 3, the liquid crystal display panel 1 includes (a) a polarization plate 2a (first polarization plate), (b) a λ/4 retardation plate 2b (first λ/4 retardation plate) in which the azimuth angle of a slow axis B is set to 45 degrees with respect to a direction parallel to a transmission axis A of the polarization plate 2a, (c) the VA mode liquid crystal layer 4, (d) the variable reflectance mirror 5, (e) the CF layer 6, (f) a λ/4 retardation plate 8a (second λ/4 retardation plate) in which a slow axis C is set to be orthogonal to the slow axis B of the λ/4 retardation plate 2b, and (g) a polarization plate 8b (second polarization plate) in which a transmission axis D is set to be orthogonal to the transmission axis A of the polarization plate 2a, in this order from an observer M side (display surface side), as optically functional layers.

The polarization plate 2a and λ/4 retardation plate 2b correspond to the first circular polarization plate 2, and the polarization plate 8a and the λ/4 retardation plate 8b correspond to the second circular polarization plate 8.

Moreover, the azimuth angle of a given direction (reference direction) in a plane parallel to the display surface is set to 0 degrees, and a state in which the transmission axis A of the polarization plate 2a is set to be parallel to the reference direction is denoted as polarization plate 2a (0). In addition, the setting of the slow axis B of the λ/4 retardation plate 2b is denoted as λ/4 retardation plate 2b (45).

The optical configuration of the liquid crystal display panel 1 may be simply described as polarization plate 2a (0)/λ/4 retardation plate 2b (45)/liquid crystal layer 4/variable reflectance mirror 5/CF layer 6/λ/4 retardation plate 8a (135)/polarization plate 8b (90), when the settings of the azimuth angle described in (a) to (g) are rewritten according to this denotation.

### Operation of Form Example 1 of Liquid Crystal Display Panel/NB Mode Reflective-Type Display

Firstly, in a case where the VA mode liquid crystal display panel 1 performs NB mode reflective-type display, the reflectance of the variable reflectance mirror 5 is set to be in a high state. The specific control method of the reflectance will be described later. Next, in setting the display to be in a dark state, a voltage applied to the liquid crystal layer 4 is set to a threshold voltage or lower. In so doing, the alignment state of the liquid crystal layer 4 becomes an initial state. On the other hand, in setting the display to be in a bright state, a voltage Va is applied to the liquid crystal layer 4 such that the retardation of the liquid crystal layer 4 becomes λ/4.

In the dark state, linearly polarized light passing through the polarization plate 2a becomes right-handed circularly polarized light, in which the electrical field vector is rotated clockwise viewed from the received light side, according to the λ/4 retardation plate 2b, and reaches the liquid crystal layer 4. In the dark state, since the liquid crystal molecules of the liquid crystal layer 4 enter a vertically aligned state, the liquid crystal layer 4 does not exhibit optical anisotropy with respect to light progressing through the liquid crystal layer 4 in the vertical direction. Accordingly, the right-handed circularly polarized light is reflected by the variable reflectance mirror 5 while keeping the polarized state.

The right-handed circularly polarized light reflected by the variable reflectance mirror 5 becomes left-handed circularly polarized light, passes through the liquid crystal layer 4 again, and is converted to linearly polarized light by the λ/4 retardation plate 2b. However, because the polarization direction of the converted linearly polarized light enters a state orthogonal to the polarization direction of the linearly polarized light when incident, light is absorbed by the polarization plate 2a. Thus, a dark state is displayed.

Moreover, for simplicity of description, the polarization direction of the linearly polarized light is described using the denotation of the azimuth angle. That is, the linearly polarized light when incident may be denoted as linearly polarized light (0), and the linearly polarized light when emitted may be denoted as linearly polarized light (90). Below, description will be made based this denotation.

In the bright state, because the retardation of the liquid crystal layer 4 is controlled to λ/4, the right-handed circularly polarized light progressing in the vertical direction through the liquid crystal layer 4 is converted to linearly polarized light and reflected by the variable reflectance mirror 5. The reflected linearly polarized light is returned to right-handed circularly polarized light by the liquid crystal layer 4, and is returned to linearly polarized light (0) by the λ/4 retardation plate 2b. Since the linearly polarized light (0) is able to pass through the polarization plate 2a (0), a bright state is displayed.

### Operation of Form Example 1 of Liquid Crystal Display Panel/NB Mode Transmissive-Type Display

Next, in a case where the VA mode liquid crystal display panel 1 performs NB mode transmissive-type display, the reflectance of the variable reflectance mirror 5 is set to be in a low state. In setting the display to be in a dark state, a voltage applied to the liquid crystal layer 4 is set to a threshold voltage or lower. On the other hand, in setting the display to be in a bright state, a voltage Vb is applied to the liquid crystal layer 4 such that the retardation of the liquid crystal layer 4 becomes λ/2. Moreover, the respective absolute values of the voltage Va and the voltage Vb establish a relationship of 0<|Va|<|Vb|.

In the dark state, light emitted from the backlight 9 (FIG. 1(b)) becomes linearly polarized light (90) by being incident on the polarization plate 8b (90), becomes left-handed circularly polarized light by the λ/4 retardation plate 8a, and reaches the liquid crystal layer 4 by passing through the CF layer 6 and the variable reflectance mirror 5.

In the dark state, as previously described, since the liquid crystal layer 4 does not exhibit optical anisotropy, the left-handed circularly polarized light is incident on the first λ/4 retardation plate 2b as is, and is converted to linearly polarized light (90). Since the linearly polarized light (90) is unable to pass through the polarization plate 2a (0), a dark state is displayed.

Meanwhile, in the bright state, because the retardation of the liquid crystal layer 4 is controlled to λ/2, the left-handed circularly polarized light progressing in the vertical direction through the liquid crystal layer 4 is converted to linearly polarized light (0) by the λ/4 retardation plate 2b after being converted to right-handed circularly polarized light. Since the linearly polarized light (0) is able to pass through the polarization plate 2a (0), a bright state is displayed.

In a case where a VA mode liquid crystal layer is applied to the liquid crystal layer 4 and the reflective and transmissive NB mode is employed, as described above, it is preferable that the transmission axis A of the polarization plate 2a and the transmission axis D of the polarization plate 8b be set to be orthogonal to each other, and the slow axis B of the λ/4 retardation plate 2b and the slow axis C of the λ/4 retardation plate 8a be set to be orthogonal to each other.

The reason for this is the influence of wavelength dispersion of the λ/4 retardation plates 2b and 8a is reduced, and the problem that coloring occurs in black is suppressed.

### Modification Example of Form Example 1 of Liquid Crystal Display Panel

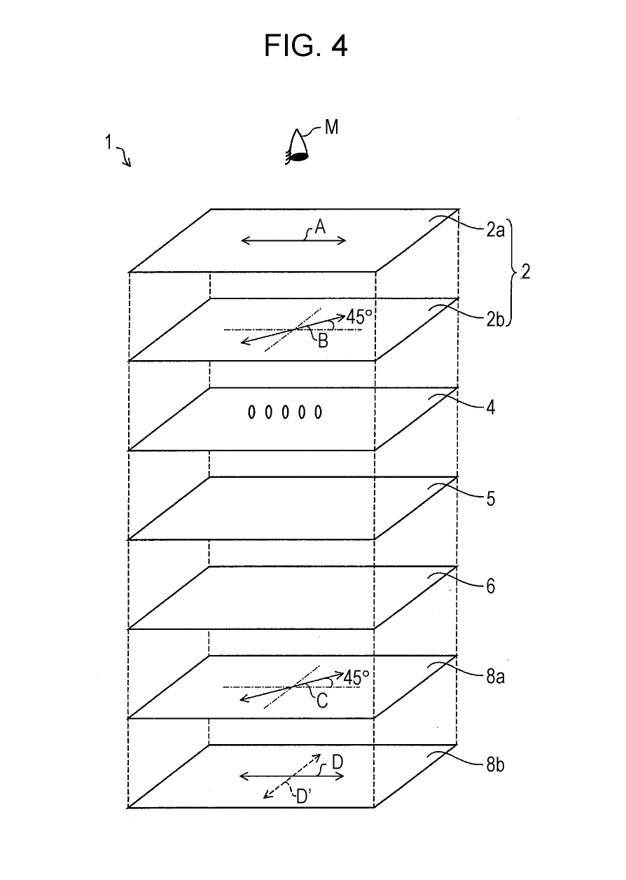

In a case where the problem of coloring of black is able to be ignored or the extent of the problem is small, the configuration shown in FIG. 3 may be substituted with the configuration shown in FIG. 4.

That is, the optical configuration of the liquid crystal display panel 1 shown in FIG. 4 is represented by polarization plate 2a (0)/λ/4 retardation plate 2b (45)/liquid crystal layer 4/variable reflectance mirror 5/CF layer 6/λ/4 retardation plate 8a (45)/polarization plate 8b (0).

### Operation of Modification Example of Form Example 1

For the operation of the liquid crystal display panel 1 shown in FIG. 4, since the reflective-type display operation is the same as the liquid crystal display panel 1 shown in FIG. 3, the transmissive-type display operation will be simply described concentrating on the differences with the liquid crystal display panel 1 shown in FIG. 3.

In the dark state, light emitted from the backlight 9 (FIG. 1(b)) becomes linearly polarized light (0) by being incident on the polarization plate 8b (0), becomes left-handed circularly polarized light by the λ/4 retardation plate 8a, and reaches the liquid crystal layer 4 by passing through the CF layer 6 and the variable reflectance mirror 5.

In the dark state, as previously described, since the liquid crystal layer 4 does not exhibit optical anisotropy, the left-handed circularly polarized light is incident on the first λ/4 retardation plate 2b as is, and is converted to linearly polarized light (90). Since the linearly polarized light (90) is unable to pass through the polarization plate 2a (0), a dark state is displayed.

Meanwhile, in the bright state, because the retardation of the liquid crystal layer 4 is controlled to λ/2, the left-handed circularly polarized light progressing in the vertical direction through the liquid crystal layer 4 is converted to linearly polarized light (0) by the λ/4 retardation plate 2b after being converted to right-handed circularly polarized light. Since the linearly polarized light (0) is able to pass through the polarization plate 2a (0), a bright state is displayed.

### Form Example 2 of Liquid Crystal Display Panel

### Reflective NB/Transmissive NW Mode

Next, a case where a reflective NB/transmissive NW mode is applied to a liquid crystal display panel 1 including a VA mode liquid crystal layer 4 will be described.

In this case, as shown by a transmission axis D′ of the polarization plate 8b (second polarization plate) in FIGS. 3 and 4 by both dashed-line arrows, the transmission axis D′ may be only made orthogonal with respect to the transmission axis D in the reflective and transmissive NB mode.

Accordingly, the optical configuration of a reflective NB/transmissive NW mode liquid crystal display panel 1 including the VA mode liquid crystal layer 4 may be simply described as polarization plate 2a (0)/λ/4 retardation plate 2b (45)/liquid crystal layer 4/variable reflectance mirror 5/CF layer 6/λ/4 retardation plate 8a (135)/polarization plate 8b (0) in the configuration example shown in FIG. 3, and may be simply described as polarization plate 2a (0)/λ/4 polarization plate 2b (45)/liquid crystal layer 4/variable reflectance mirror 5/CF layer 6/λ/4 retardation plate 8a (45)/polarization plate 8b (90) in the configuration example shown in FIG. 4.

### Operation of Form Example 2/NW Mode Transmissive-Type Display

The content of the operation in which the liquid crystal display panel 1 (FIG. 3) of Form Example 2 performs NB mode reflective-type display is entirely the same as the content of the operation in which the liquid crystal display panel 1 of Form Example 1 performs NB mode reflective-type display. Accordingly, the operation of Form Example 2 will be simply described concentrating on the transmissive NW mode.

In the transmissive NW mode, the reflectance of the variable reflectance mirror 5 is set to a low state. Then, differently from the transmissive NB mode, when display is set to be in a bright state, the voltage applied to the liquid crystal layer 4 is set to a threshold voltage or lower. Meanwhile, when display is set to be in a dark state, a voltage is applied to the liquid crystal layer 4 such that the retardation of the liquid crystal layer 4 becomes λ/2.

In the bright state, light emitted from the backlight 9 (FIG. 1(b)) becomes linearly polarized light (0) by being incident on the polarization plate 8b (0), becomes right-handed circularly polarized light by the λ/4 retardation plate 8a (135), and reaches the liquid crystal layer 4 by passing through the CF layer 6 and the variable reflectance mirror 5.

In the bright state, since the liquid crystal layer 4 does not exhibit optical anisotropy, the right-handed circularly polarized light is incident on the first λ/4 retardation plate 2b (45) as is, and is converted to linearly polarized light (0). Since the linearly polarized light (0) passes through the polarization plate 2a (0), a bright state (normally white) is displayed.

Meanwhile, in the dark state, because the retardation of the liquid crystal layer 4 is controlled to λ/2, the right-handed circularly polarized light progressing in the vertical direction through the liquid crystal layer 4 is converted to linearly polarized light (90) by the λ/4 retardation plate 2b after being converted to left-handed circularly polarized light. Since the linearly polarized light (90) is unable to pass through the polarization plate 2a (0), a dark state is displayed.

### Operation of Modification Example of Form Example 2/NW Mode Transmissive-Type Display

The operation of the liquid crystal display panel 1 (FIG. 4) as a modification example of Form Example 2 will also be simply described concentrating on the transmissive NW mode.

In either of the bright state and the dark state, light emitted from the backlight 9 (FIG. 1(b)) becomes linearly polarized light (90) by being incident on the polarization plate 8b (90), and is converted to right-handed circularly polarized light by the λ/4 retardation plate 8a (45). Since the operation relating to the control of the transmission and non-transmission of the polarization plate 2a (0) of the right-handed circularly polarized light according to control of the retardation of the liquid crystal layer 4 is entirely the same as in Form Example 2 shown in FIG. 3, and description thereof will not be made.

(Reflectance of Variable Reflectance Mirror in Transmissive NW Mode)

In the transmissive NW mode, the reflectance of the variable reflectance mirror 5 is preferably low, and being 0% (completely transparent state) is most preferable.

This is because, if the variable reflectance mirror 5 has residual reflection, a defect (negative-positive inversion phenomenon) may be incurred in which the dark state of the reflective NB mode previously described occurs at the same time in the bright state of the transmissive NW mode, and the bright state of the reflective NB mode occurs at the same time in the dark state of the transmissive NW mode. This defect brings about a lowering of contrast. Accordingly, the closer the reflectance of the variable reflectance mirror 5 approaches 0%, the more the lowering of the contrast in the transmissive NW mode is suppressed.

The above point is shared by the NW mode transmissive-type display regardless of the mode of the liquid crystal layer 4.

### Form Example 3 of Liquid Crystal Layer

### Reflective and Transmissive NB Mode

Next a case where an In-Plane-Switching (IPS) mode liquid crystal layer is applied to the liquid crystal layer 4 will be described. In the IPS mode, both of a pixel electrode and a counter electrode are formed on the TFT substrate 3. In addition, the liquid crystal layer 4, as an example, is horizontally aligned so as to be parallel or orthogonal to the reference direction (azimuth angle 0 degrees) and is formed by a p-type liquid crystal having λ/2 retardation.

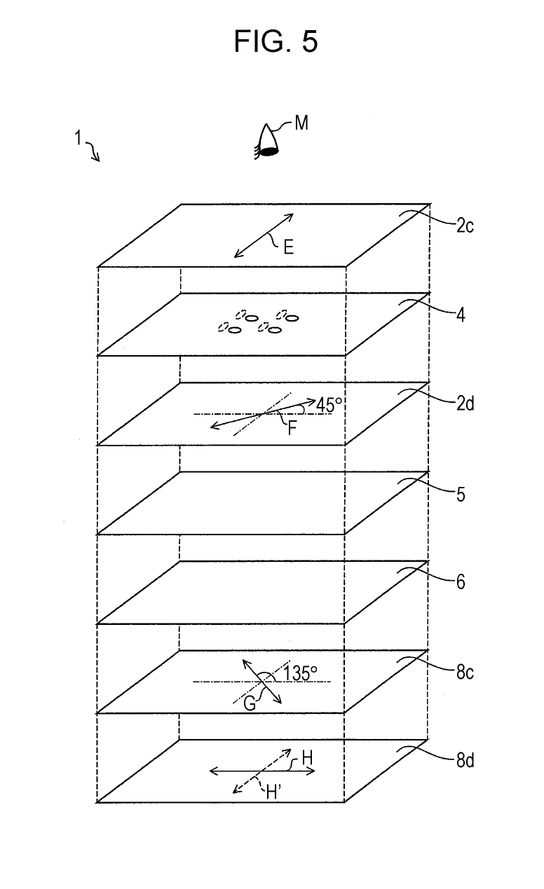

FIG. 5 is a diagram schematically describing various optically functional layers configuring a liquid crystal display panel 1 including an IPS mode liquid crystal layer 4.

As shown in FIG. 5, the liquid crystal display panel 1 includes (h) a polarization plate 2c (third polarization plate) in which a transmission axis is set to be orthogonal to a reference direction set in a face parallel to the display surface, (i) an IPS mode liquid crystal layer 4, (j) a λ/4 retardation plate 2d (third λ/4 retardation plate) in which the azimuth angle of a slow axis F is set to be 45 degrees with respect to the reference direction, (k) the variable reflectance mirror 5, (l) the CF layer 6, (m) a λ/4 retardation plate 8c (fourth λ/4 retardation plate) in which a slow axis G is set to be orthogonal with respect to the slow axis F of the λ/4 retardation plate 2d, and (n) a polarization plate 8d (fourth polarization plate) in which a transmission axis H is set to be orthogonal with respect to the transmission axis E of the polarization plate 2c, in this order from an observer M side (display surface side), as optically functional layers.

If the settings of the azimuth angle disclosed in (h) to (n) are rewritten according to the above-described denotation, the optical configuration of the liquid crystal display panel 1 may be simply described as polarization plate 2c (90)/liquid crystal layer 4 (0 or 90)/λ/4 retardation plate 2d (45)/variable reflectance mirror 5/CF layer 6/λ/4 retardation plate 8c (135)/polarization plate 8d (0).

### Operation of Form Example 3 of Liquid Crystal Layer/NB Mode Reflective-Type Display

Firstly, a case where the IPS mode liquid crystal display panel 1 performs NB mode reflective-type display, the reflectance of the variable reflectance mirror 5 is set to be in a high state. Next, in setting the display to be in a dark state, a voltage applied to the liquid crystal layer 4 is set to a threshold voltage or lower. Meanwhile, in setting display to be in a bright state, a voltage Vc is applied to the liquid crystal layer 4 such that the director of the liquid crystal layer 4 becomes 22.5 degrees with respect to the reference direction.

In the dark state, the linearly polarized light (90) passing through the polarization plate 2c (90) is incident on the liquid crystal layer 4 (0 or 90) and passes therethrough with the polarization state of the linearly polarized light (90) held as is. Subsequently, the linearly polarized light (90) becomes left-handed circularly polarized light by the λ/4 retardation plate 2d and is reflected by the variable reflectance mirror 5.

The left-handed circularly polarized light reflected by the variable reflectance mirror 5 becomes right-handed circularly polarized light, is incident on the λ/4 retardation plate 2d again, and is converted to linearly polarized light (0) by the λ/4 retardation plate 2d. The linearly polarized light (0) passes through the liquid crystal layer 4 (0 or 90) with the polarization state held as is. However, since the light is unable to pass through the polarization plate 2c (90), a dark state is displayed.

Meanwhile, in the bright state, because the director of the liquid crystal layer 4 is controlled to 22.5 degrees, the linearly polarized light (90) progressing in the vertical direction through the liquid crystal layer 4 becomes linearly polarized light (135) by the retardation λ/2 of the liquid crystal layer 4 of which the director is controlled to 22.5 degrees. Since there is no influence from the λ/4 retardation plate 2d having a slow axis F orthogonal to the polarization direction of the linearly polarized light (135), the linearly polarized light (135) is reflected by the variable reflectance mirror 5 with the polarization state maintained as is.

The reflected linearly polarized light (135), similarly to above, is converted to linearly polarized light (90) by the liquid crystal layer 4 of which the director is controlled to 22.5 degrees without influence from the λ/4 retardation plate 2d, and is able to pass through the polarization plate 2c (90). In so doing, a bright state is displayed.

### Operation of Form Example 3 of Liquid Crystal Layer/NB Mode Transmissive-Type Display

Next, in a case where the IPS mode liquid crystal display panel 1 performs NB mode transmissive-type display, the reflectance of the variable reflectance mirror 5 is set to a low state. In setting the display to be in a dark state, a voltage applied to the liquid crystal layer 4 is set to a threshold voltage or lower. Meanwhile, in setting the display to be in a bright state, a voltage Vd is applied to the liquid crystal layer 4 such that the director of the liquid crystal layer 4 becomes 45 degrees. Moreover, the respective absolute values of the voltage Vc and the voltage Vd establish a relationship of 0<|Vc|<|Vd|.

In the dark state, light emitted from the backlight 9 (FIG. 1(b)) becomes linearly polarized light (0) by being incident on the polarization plate 8d (0), becomes right-handed circularly polarized light by the λ/4 retardation plate 8c (135), and reaches the λ/4 retardation plate 2d (45) by passing through the CF layer 6 and the variable reflectance mirror 5. The right-handed circularly polarized light is converted to linearly polarized light (0) by the λ/4 retardation plate 2d (45). The linearly polarized light (0) passes through the liquid crystal layer 4 (0 or 90) with the polarization state held as is; however, since the light is unable to pass through the polarization plate 2c (90), a dark state is displayed.

Meanwhile, in the bright state, the linearly polarized light (0) progressing in the vertical direction through the liquid crystal layer 4 is converted to linearly polarized light (90) by the p-type liquid crystal having λ/2 retardation and in which the director of the liquid crystal layer 4 is controlled to 45 degrees. Since the linearly polarized light (90) is able to pass through the polarization plate 2c (90), a bright state is displayed.

### Modification Example of Form Example 3 of Liquid Crystal Layer

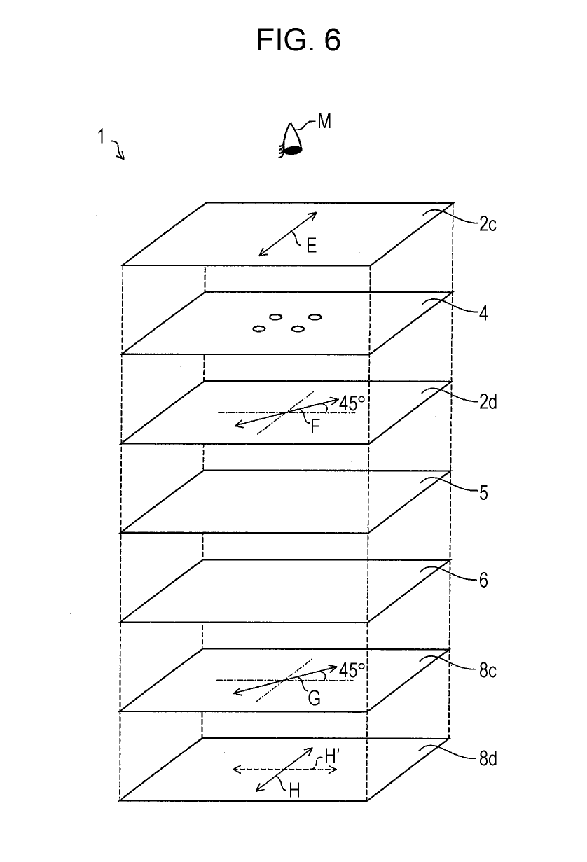

As previously described for a reflective and transmissive NB mode liquid crystal display panel 1 including a VA mode liquid crystal layer 4, also for the reflective and transmissive NB mode liquid crystal display panel 1 to which the IPS mode liquid crystal layer 4 is applied, the configuration shown in FIG. 5 may be substituted with the configuration shown in FIG. 6 in a case where the above-described problem of coloring of the black is able to be ignored. In the configuration shown in FIG. 6, the respective slow axes F and G of the λ/4 retardation plate 2d and λ/4 retardation plate 8c are set to be parallel, and the respective transmission axes E and H of the polarization plate 2c and polarization plate 8d are set to be parallel.

That is, the optical configuration of the liquid crystal display panel 1 shown in FIG. 6 is represented as polarization plate 2a (90)/liquid crystal layer 4 (0 or 90)/λ/4 retardation plate 2d (45)/variable reflectance mirror 5/CF layer 6/λ/4 retardation plate 8c (45)/polarization plate 8d (90).

### Operation of Modification Example of Form Example 3

For the operation of the liquid crystal display panel 1 shown in FIG. 6, since the reflective-type display operation is the same as the liquid crystal display panel 1 shown in FIG. 5, the transmissive-type display operation will be simply described concentrating on the differences with the liquid crystal display panel 1 shown in FIG. 5.

In the dark state, light emitted from the backlight 9 (FIG. 1(b)) becomes linearly polarized light (90) by being incident on the polarization plate 8d (90), becomes right-handed circularly polarized light by the λ/4 retardation plate 8c, and reaches the λ/4 retardation plate 2d by passing through the CF layer 6 and the variable reflectance mirror 5. The right-handed circularly polarized light is converted to linearly polarized light (0) by the λ/4 retardation plate 2d. The linearly polarized light (0) passes through the liquid crystal layer 4 (0 or 90) with the polarization state held as is; however, since the light is unable to pass through the polarization plate 2c (90), a dark state is displayed.

Meanwhile, in the bright state, the linearly polarized light (0) progressing in the vertical direction through the liquid crystal layer 4 is converted to linearly polarized light (90) by the p-type liquid crystal having λ/2 retardation and in which the director of the liquid crystal layer 4 is controlled to 45 degrees. Since the linearly polarized light (90) is able to pass through the polarization plate 2c (90), a bright state is displayed.

### Form Example 4 of Liquid Crystal Display Panel

### Reflective NB/Transmissive NW Mode

Next, a case where a reflective NB/transmissive NW mode is applied to a liquid crystal display panel 1 including an IPS mode liquid crystal layer 4 will be described.

In this case, as shown by a transmission axis H′ of the polarization plate 8d (fourth polarization plate) in FIGS. 5 and 6 by both dashed-line arrows, the transmission H′ may be only made orthogonal with respect to the transmission axis H in the reflective and transmissive NB mode.

Accordingly, the optical configuration of a reflective NB/transmissive NW mode liquid crystal display panel 1 including an IPS mode liquid crystal layer 4 may be simply described as polarization plate 2c (90)/liquid crystal layer 4 (0 or 90)/λ/4 retardation plate 2d (45)/variable reflectance mirror 5/CF layer 6/λ/4 retardation plate 8c (135)/polarization plate 8d (90) in the configuration example shown in FIG. 5, and may be simply described as polarization plate 2c (90)/liquid crystal layer 4 (0 or 90)/λ/4 retardation plate 2d (45)/variable reflectance mirror 5/CF layer 6/λ/4 retardation plate 8c (45)/polarization plate 8d (0) in the configuration example shown in FIG. 6.

### Operation of Form Example 4/NW Mode Transmissive-Type Display

The content of the operation in which the liquid crystal display panel 1 of Form Example 4 performs NB mode reflective-type display is entirely the same as the content of the operation in which the liquid crystal display panel 1 of Form Example 3 performs NB mode reflective-type display. Accordingly, the operation of Form Example 4 will be simply described concentrating on the transmissive NW mode.

In the transmissive NW mode, the reflectance of the variable reflectance mirror 5 is set to a low state. Then, differently from the transmissive NB mode, when display is set to be in a bright state, the voltage applied to the liquid crystal layer 4 is set to a threshold voltage or lower. Meanwhile, in setting the display to be in a dark state, a voltage is applied to the liquid crystal layer 4 such that the director of the liquid crystal layer 4 becomes 45 degrees.

In the bright state, light emitted from the backlight 9 (FIG. 1(b)) becomes linearly polarized light (90) by being incident on the polarization plate 8d (90), becomes left-handed circularly polarized light by the λ/4 retardation plate 8c (135), and reaches the λ/4 retardation plate 2d (45) by passing through the CF layer 6 and the variable reflectance mirror 5. The left-handed circularly polarized light is converted to linearly polarized light (90) by the λ/4 retardation plate 2d (45). The linearly polarized light (90) passes through the liquid crystal layer 4 (0 or 90) with the polarization state held as is; however, since the light is able to pass through the polarization plate 2c (90), a bright state is displayed.

Meanwhile, in the dark state, the linearly polarized light (90) progressing in the vertical direction through the liquid crystal layer 4 is converted to linearly polarized light (0) by the p-type liquid crystal having λ/2 retardation and in which the director of the liquid crystal layer 4 is controlled to 45 degrees. Since the linearly polarized light (0) is unable to pass through the polarization plate 2c (90), a dark state is displayed.

### Operation of Modification Example of Form Example 4/NW mode Transmissive-Type Display

The operation of the liquid crystal display panel 1 (FIG. 6) as a modification example of Form Example 4 will also be simply described concentrating on the transmissive NW mode.

In either of the bright state and the dark state, light emitted from the backlight 9 (FIG. 1(b)) becomes linearly polarized light (0) by being incident on the polarization plate 8d (0), and is converted to left-handed circularly polarized light by the λ/4 retardation plate 8c (45). Since the operation related to the control of transmission and non-transmission of the polarization plate 2c (90) by the left-handed circularly polarized light according to control of the retardation of the liquid crystal layer 4 is entirely the same as Form Example 4 shown in FIG. 5, description thereof will not be made.

### Form Example 5 of Liquid Crystal Display Panel

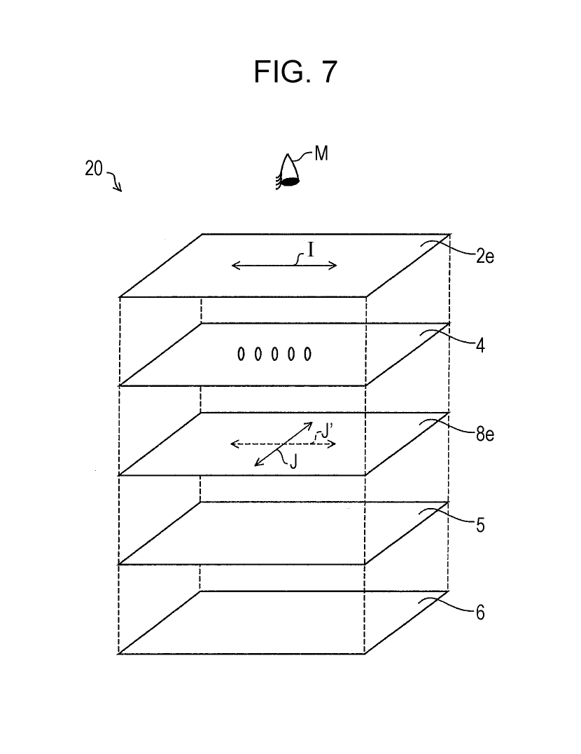

Next, as a substitution example of the liquid crystal display panel 1, the reflective and transmissive NB mode liquid crystal display panel 20 will be described with reference to FIG. 7. FIG. 7 is a diagram schematically describing a configuration of a liquid crystal display panel 20 including an in-cell polarization plate 8e.

As shown in FIG. 7, the liquid crystal display panel 20 includes (o) a polarization plate 2e (fifth polarization plate), (p) a liquid crystal layer 4 expressing λ/2 retardation such that a polarization state is changed due to voltage application in a bright state while liquid crystal molecules maintain an initial alignment state in a dark state, (q) an in-cell polarization plate 8e in which a transmission axis J is set to be orthogonal with respect to a transmission axis I of the polarization plate 2e, (r) the variable reflectance mirror 5, and (s) the CF layer 6, in this order from an observer M side (display surface side), as optically functional layers.

In addition, a polarization plate in which the transmission axis is set to be parallel with the transmission axis of the in-cell polarization plate 8e may be provided to further to the rear face side of the CF layer 6. In the case of an in-cell polarization plate, simple polarization plates with a cross Nichol and parallel Nichol transmittance ratio from 10 to approximately 1000 are numerous, and it is possible to use a display using these in reflective-type display; however, there are cases in which contrast is insufficient in transmissive-type display. Here, by arranging a polarization plate with a transmittance ratio of 1000 or higher, it is possible to obtain a transmissive-type display with sufficient contrast.

Moreover, as a liquid crystal layer 4 satisfying the provision of (p), it is possible to use a VA mode liquid crystal layer configured by an n-type liquid crystal vertically aligned during non-application of a voltage. In the bright state, a voltage is applied to the liquid crystal layer 4 such that the liquid crystal layer 4 expresses λ/2 retardation. In this case, it is possible to employ a known method such as forming a rib on the inner face of the substrates interposing the liquid crystal layer 4, or regulating the inclination direction of the liquid crystal molecules through patterning of the electrode or an alignment film. In so doing, the liquid crystal molecules are inclined according to the strength of the electric field such that the λ/2 slow axis has an angle of 45 degrees or −45 degrees with respect to the transmission axis of the polarization plate 2e.

Furthermore, as other liquid crystal layers 4 satisfying the provision of (p), it is possible to use an IPS mode liquid crystal layer horizontally aligned along the reference direction (0) in the dark state (state of non-application of a voltage, initial state) and horizontally aligned to 45 degrees or −45 degrees through application of a voltage in the bright state.

In addition, as a method of manufacturing the in-cell polarization plate 8e, it is possible to employ a method of coating and drying an azo-based dye, a benzidine-based dye, a stilbene-based dye or the like on, for example, a film of polyimide or the like subjected to alignment processing by rubbing or the like.

The transmission axis I of the polarization plate 2e is set to be parallel to the reference direction (0). If the settings of the azimuth angle disclosed in (o) to (s) are rewritten according to the above-described denotation, the optical configuration of the liquid crystal display panel 20 may be simply described as polarization plate 2e (0)/liquid crystal layer 4/in-cell polarization plate 8e (90)/variable reflectance mirror 5/CF layer 6.

Moreover, when the configuration of FIGS. 3 to 6 is compared to the configuration of FIG. 7, the configuration of FIG. 7 including the in-cell polarization plate 8e becomes a simple configuration by omitting two λ/4 retardation plates. This is because it is necessary to design the configuration of the liquid crystal display panel with the assumption that the configuration of FIGS. 3 to 6 should be provided with a λ/4 retardation plate on the light incident side in order to create a dark state.

However, although not shown in the drawings, even in case of a configuration using the in-cell polarization plate 8e, it is preferable to provide an internally attached λ/4 retardation plate on the in-cell polarization plate (observer side) together with providing a λ/4 retardation plate on the light incident side in order to increase the contrast.

The optical configuration of the liquid crystal display panel in this case is set as polarization plate 2e (0)/λ/4 retardation plate (45)/liquid crystal layer 4/λ/4 retardation plate (135)/in-cell polarization plate 8e (90)/variable reflectance mirror 5/CF layer 6.

In this configuration, light directly incident on the face of the observer side of the TFT wirings becomes right-handed circularly polarized light, light reflected by the TFT wirings becomes left-handed circularly polarized light, and is unable to pass through the polarization plate 2e. As a result, because it is possible to set the reflection of the TFT wirings on the observer side to be in a black state, it is possible to increase the contrast.

Partially providing a low reflection film, such as the above-mentioned low reflection chromium or nickel alloy, between the wiring and the TFT substrate 3 (substrate provided with wiring) or the first circular polarization plate 2 (polarization plate on display surface side) is particularly effective in a configuration not setting light directly incident on the face on the observer side of the TFT wiring to circularly polarized light.

Moreover, the internally attached λ/4 retardation plate, for example, is obtained through UV exposure after coating and drying a liquid crystalline UV curable resin on a polyimide film subjected to alignment processing through an optical alignment or rubbing process or the like.

Below, the operation of a configuration example not provided with a λ/4 retardation plate will be described.

### Operation of Form Example 5/NB Mode Reflective-Type Display

First, in a case where the reflective and transmissive NB mode liquid crystal display panel 20 performs NB mode reflective-type display, the reflectance of the variable reflectance mirror 5 is set to be in a high state.

Next, in setting the display to be in a dark state, a voltage applied to the liquid crystal layer 4 is set to a threshold voltage or lower. As a result, the VA mode or IPS mode liquid crystal layer 4 maintains the initial alignment state. Meanwhile, in setting the display to be in the bright state, in the case of VA mode, a voltage is applied to the liquid crystal layer 4 such that the liquid crystal layer 4 expresses λ/2 retardation. In addition, in the case of IPS mode, a voltage is applied to the liquid crystal layer 4 such that the director of the liquid crystal layer 4 having λ/2 retardation becomes 45 degrees with respect to the reference direction.

In the dark state, the linearly polarized light (0) passing through the polarization plate 2e (0) is incident on the liquid crystal layer 4, passes therethrough with the polarization state of the linearly polarized light (0) held as is, and is incident on the in-cell polarization plate 8e (90). As a result, because the linearly polarized light (0) is absorbed by the in-cell polarization plate 8e (90), a dark state is displayed.

Meanwhile, in the bright state, because the liquid crystal layer 4 is controlled by voltage application so as to express λ/2 retardation, linearly polarized light (0) passing through the polarization plate 2e (0) is converted to linearly polarized light (90) by passing through the liquid crystal layer 4.

The linearly polarized light (90) passes through the in-cell polarization plate 8e (90), and reflected by the variable reflectance mirror 5.

The reflected linearly polarized light (90) passes through the in-cell polarization plate 8e (90) again, and is converted to linearly polarized light (0) through returning back through the liquid crystal layer 4. Since the linearly polarized light (0) is transmitted through the polarization plate 2e (0), the bright state is displayed.

### Operation of Form Example 5/NB Mode Transmissive-Type Display

Next, in a case where the reflective and transmissive NB mode liquid crystal display panel 20 performs NB mode transmissive-type display, the reflectance of the variable reflectance mirror 5 is set to a low state. Control of the alignment state of the liquid crystal layer 4 according to display of the dark state or the bright state is the same as control with the NB mode reflective-type display.

In the dark state, the light emitted by the backlight 9 (FIG. 1(b)) passes through the CF layer 6 and the variable reflectance mirror 5, and reaches the in-cell polarization plate 8e (90). The linearly polarized light (90) emitted from the in-cell polarization plate 8e (90) passes through the liquid crystal layer 4 controlled to the initial alignment state with the polarization state held as is.

As a result, because the linearly polarized light (90) is absorbed by the polarization plate 2e (0), the dark state is displayed.

Meanwhile, in the bright state, the linearly polarized light (90) emitted from the in-cell polarization plate 8e (90) similarly to above is converted to linearly polarized light (0) by passing through the liquid crystal layer 4 controlled so as to express λ/2 retardation.

As a result, because the linearly polarized light (0) is able to pass through the polarization plate 2e (0), the bright state is displayed. The NB mode liquid crystal display panel 20 is able to provide a brighter transmissive-type display than the NB mode liquid crystal display panel 1 shown in FIG. 3 to FIG. 6. This is because the liquid crystal display panel 20 omits the λ/4 retardation plates 2b and 8a or the λ/4 retardation plates 2d and 8c of the liquid crystal display panel 1.

As a more significant effect, in the liquid crystal display panel 20, it is possible for the setting of the voltage driving the liquid crystal layer 4 according to the dark state and the bright state to be the same as the reflective-type display and the transmissive-type display. As a result, it is possible for the design of the cell thickness to be optimized for both of the reflective-type display and the transmissive-type display at the same time. In other words, it is possible to make design of the optimal cell thickness or the like shared in the reflective-type display and the transmissive-type display, and possible to achieve a simplification of the design.

### Modification Example of Form Example 5

### Reflective and Transmissive NW Mode

Next, a case where the reflective and transmissive NW mode is applied to a liquid crystal display panel 20 including an in-cell polarization plate 8e will be described.

In this case, as shown in the transmission axis J′ of the in-cell polarization plate 8e by both dashed-line arrows in FIG. 7, the transmission axis J′ may be only made orthogonal with respect to the transmission axis J in the reflective and transmissive NB mode.

Accordingly, the optical configuration of a reflective and transmissive NW mode liquid crystal display panel 20 including the in-cell polarization plate 8e may be simply described as polarization plate 2e (0)/liquid crystal layer 4/in-cell polarization plate 8e (0)/variable reflectance mirror 5/CF layer 6.

### Operation of Modification Example of Form Example 5/NW Mode Reflective-Type Display

First, in a case where the reflective and transmissive NW mode liquid crystal display panel 20 performs NW mode reflective-type display, the reflectance of the variable reflectance mirror 5 is set to be in a high state.

Next, in setting the display to be in a bright state, a voltage applied to the liquid crystal layer 4 is set to a threshold voltage or lower. As a result, the VA mode or IPS mode liquid crystal layer 4 maintains the initial alignment state. Meanwhile, in setting the display to the dark state, in the case of VA mode, a voltage is applied to the liquid crystal layer 4 such that the liquid crystal layer 4 expresses λ/2 retardation. In addition, in the case of IPS mode, a voltage is applied to the liquid crystal layer 4 such that the director of the liquid crystal layer 4 having λ/2 retardation becomes 45 degrees with respect to the reference direction.

In the bright state, since the liquid crystal layer 4 maintains the initial alignment state, the linearly polarized light (0) passing through the polarization plate 2e (0) is transmitted through the liquid crystal layer 4 and the in-cell polarization plate 8e (0), and returns to the polarization plate 2e (0) with the polarization state of the linearly polarized light (0) held as is, after being reflected by the variable reflectance mirror 5. Since the linearly polarized light (0) is transmitted through the polarization plate 2e (0), the bright state is displayed.

Meanwhile, in the dark state, because the liquid crystal layer 4 is controlled by voltage application so as to express λ/2 retardation, linearly polarized light (0) passing through the polarization plate 2e (0) is converted to linearly polarized light (90) by passing through the liquid crystal layer 4. As a result, because the linearly polarized light (90) is absorbed by the in-cell polarization plate 8e (0), the dark state is displayed.

### Operation of Modification Example of Form Example 5/NW Mode Transmissive-Type Display

Next, in a case where the reflective and transmissive NW mode liquid crystal display panel 20 performs NW mode transmissive-type display, the reflectance of the variable reflectance mirror 5 is set to a low state. Control of the alignment state of the liquid crystal layer 4 according to display of the dark state or the bright state is the same as the control with the NB mode reflective-type display.

In the bright state, the light emitted by the backlight 9 (FIG. 1(b)) passes through the CF layer 6 and the variable reflectance mirror 5, and reaches the in-cell polarization plate 8e (0). The linearly polarized light (0) emitted from the in-cell polarization plate 8e (0) passes through the liquid crystal layer 4 controlled to the initial alignment state with the polarization state held as is. As a result, because the linearly polarized light (0) passes through the polarization plate 2e (0), the bright state is displayed.

Meanwhile, in the dark state, the linearly polarized light (0) emitted from the in-cell polarization plate 8e (90) similarly to above is converted to linearly polarized light (90) by passing through the liquid crystal layer 4 controlled so as to express λ/2 retardation. As a result, because the linearly polarized light (90) is unable to pass through the polarization plate 2e (0), the dark state is displayed.

### Configuration Example 1 of Variable Reflectance Mirror

It is possible to use an element able to switch between a reflective state with a reflectance of 50% or higher, and preferably 90% or higher, and a transparent state with a reflectance lower than 50% and preferably 20% or lower as a variable reflectance layer such as the variable reflectance mirror 5. As a representative element thereof, an element able to switch between a reflective state and a transparent state through injection of hydrogen gas, and preferably application of a voltage, is known.

For example, the element able to switch between a reflective state and a transparent state through application of a voltage is disclosed in NPL 1 listed above.

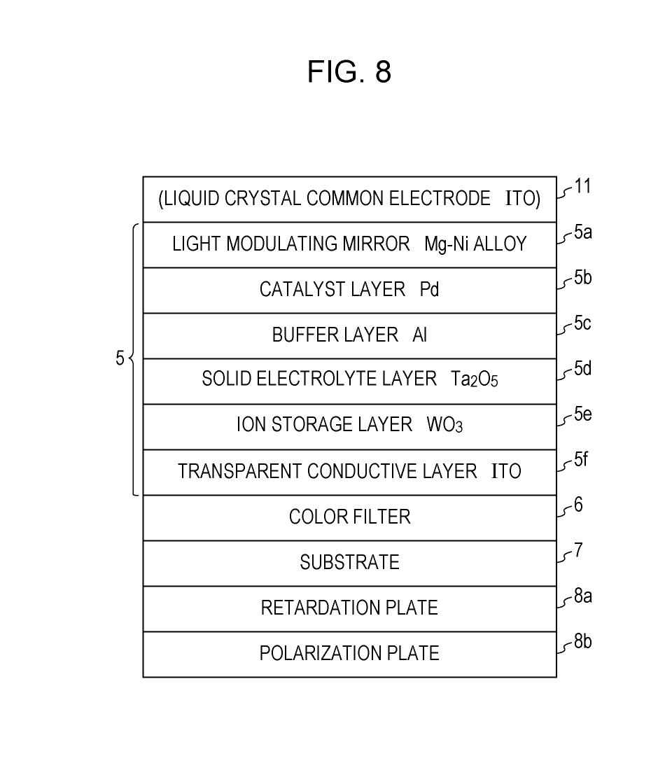

FIG. 8 is a configuration diagram showing the main parts of a configuration of a liquid crystal display panel according to an embodiment of the present invention, including a variable reflectance mirror 5 configured by a multi-layer film as disclosed in NPL 1.

The variable reflectance mirror 5 shown in FIG. 8 is provided in the liquid crystal display panel 1 or 20, and is arranged between a common electrode 11 formed from ITO or the like, and the CF layer 6.

More specifically, the variable reflectance mirror 5 is formed by laminating a light modulating mirror layer 5a, a catalyst layer 5b, a buffer layer 5c, a solid electrolyte layer 5d, an ion storage layer 5e and a transparent conductive layer 5f in this order. Moreover, the lamination order of each layer 5a to 5f may be in reverse order to the above.

The light modulating mirror layer 5a is formed from an Mg—Ni alloy or an Mg—Ca alloy. The catalyst layer 5b is configured from palladium (Pd). The solid electrolyte layer 5d is configured from Ta₂O₅. The ion storage layer 5e is configured from WO₃. The transparent conductive layer 5f is configured from ITO.

With the potential of the common electrode 11 as a reference, the light modulating mirror layer 5a enters a transparent state by application of a voltage at which the transparent conductive layer 5f has a positive potential with respect to the potential of the common electrode 11 to the transparent conductive layer 5f. Meanwhile, the light modulating mirror layer 5a enters a reflective state by application of a voltage at which the transparent conductive layer 5f has a negative potential with respect to the potential of the common electrode 11 to the transparent conductive layer 5f. In this way, the variable reflectance mirror 5 is able to switch between the reflective state and the transparent state by switching the light modulating mirror layer 5a between the reflective state and the transparent state.

Instead of the configuration example in FIG. 8, it is possible to use a configuration or the like in which silver is precipitated through a reduction reaction due to application of a voltage to a solution including silver ions, such as silver iodide. In addition, a high viscosity liquid in which polyvinyl butyral (PVB) or the like is dissolved with respect to the solution may be used. Furthermore, a liquid gelled though curing by application of light or heat after a photo-polymerizable or thermally polymerizable monomer is dissolved with respect to the solution may be used. Furthermore, a solid electrolyte using a polymer such as polyethylene oxide or a plastic crystal such as succinonitrile may be used.

### Configuration Example 2 of Variable Reflectance Mirror

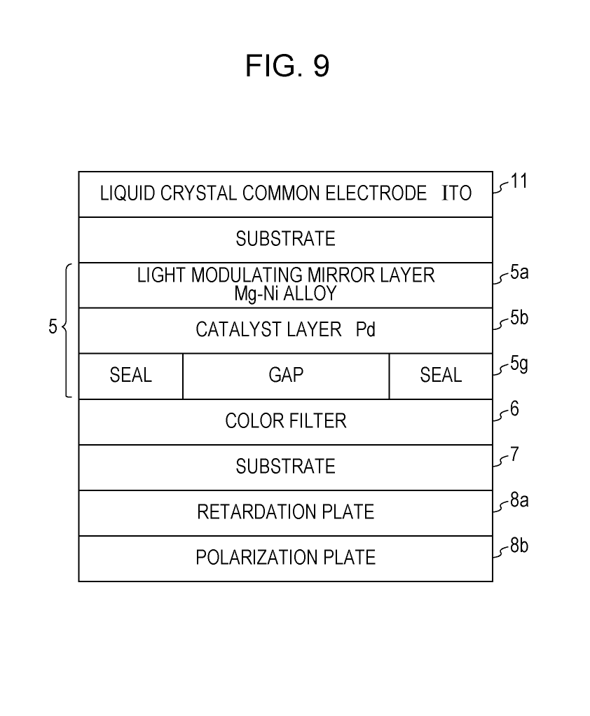

FIG. 9 is a configuration diagram showing a modification example of a variable reflectance mirror 5.

The variable reflectance mirror 5 shown in FIG. 9 is an element able to switch between the reflective state and the transparent state by injection of hydrogen gas, and a similar example is disclosed in the above NPL 1.

More specifically, the variable reflectance mirror 5 is configured by laminating the light modulating mirror layer 5a, the catalyst layer 5b and a hydrogen gas introduction layer 5g in this order. Between the catalyst layer 5b and the CF layer 6, a gap is formed into which gas is sent, and the periphery of the gap is sealed excepting a gas injection port. Moreover, the lamination order of each layer 5a, 5b and 5g may be in reverse order to the above.

The reflective state is obtained by injecting a gas including oxygen, for example, argon gas with 4% oxygen into the gap through an injection port (not shown in the drawings) provided on the side face of the hydrogen gas introduction layer 5g, and the transparent state is obtained by injecting a gas including hydrogen, for example argon gas with 4% hydrogen.

### Embodiment 2

Below, another embodiment according to the present invention will be described. Moreover, for convenience of description, members having the same function as in the diagrams described by the embodiments have the same reference numerals applied thereto and description thereof will not be made.

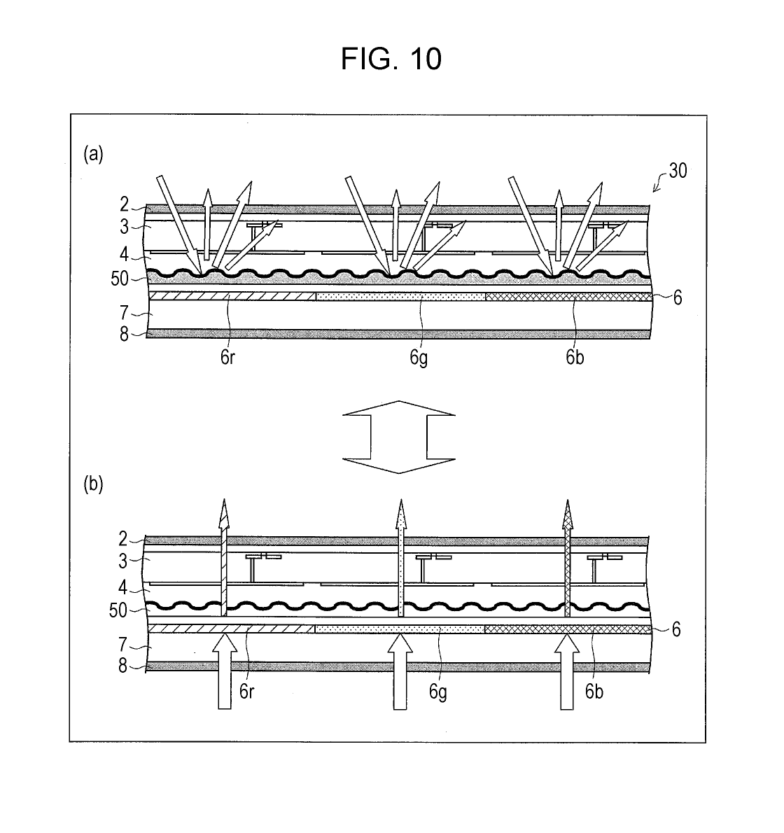

FIG. 10(a) is a schematic diagram showing a laminated configuration example of a liquid crystal display panel 30 according to an embodiment of the present invention in a state of reflective-type display. FIG. 10(b) is a schematic diagram showing a laminated configuration example of a liquid crystal display panel 30 according to an embodiment of the present invention in a state of transmissive-type display.

The point of difference between the liquid crystal display panel 1 and the liquid crystal display panel 20, and liquid crystal display panel 30 is that the liquid crystal display panel 30 includes a variable reflectance mirror 50 having a light scattering function in the reflective state.

A plurality of convex portions, for example, are formed on the surface of the observer side of the variable reflectance mirror 50. The height of each convex portion is set to, for example, 0.5 μm to 3 μm.

In a case of manufacturing a variable reflectance mirror 50 with a multi-layer format described with reference to FIG. 8, the concave portions are formed with a method such as a sandblasting process with respect to the CF substrate 7. A color resist configuring the CF layer 6 is laminated on the CF substrate 7 subjected to such a surface treatment, and the transparent conductive layer 5f to the light modulating mirror layer 5a are further laminated in order.

In addition to such a method of manufacturing, there is another method in which a photosensitive transparent resin is coated on the CF layer 6, after which a transparent resin layer having convex portions is formed through a known method in which pattern exposure and thermal sagging are performed, and a transparent conductive layer 5f or the like is laminated thereon in order.

Since the variable reflectance mirror 50 has a light scattering function, it is possible to increase the amount of reflected light in a direction other than the specular reflection direction with respect to the reflective surface. In so doing, it is possible to perform brighter reflective-type display with increased contrast with respect to a direction other than the specular reflection direction with respect to the reflective surface, in other words, it is possible to perform reflective-type display with a wider viewing angle.

In addition, in the liquid crystal display panel 30 according to an embodiment of the present invention, because the problem of parallax caused by the thickness of the CF substrate 7 as described above does not occur, it is possible to provide a reflective-type display with much improved display quality through the occurrence of parallax being suppressed.

In this way, the light modulating mirror layer 5a which is a location forming a mirror in the variable reflectance mirror 50 is able to perform display with a wide viewing angle during performance of reflective-type display by having a light scattering function in the reflective state without providing a separate light scattering film or the like.

In addition, light being particularly strongly scattered occurs when the variable reflectance mirror 50 is set to the reflective state and reflective-type display is performed, as shown in FIG. 10(a), and the light scattering function is not exhibited during performance of transmissive-type display, as shown in FIG. 10(b). Therefore, the polarization state of light emitted from the backlight 9 and passing through the second circular polarization plate 8 is not disturbed by scattering. As a result, since the contrast of the display does not lower, in the transmissive-type display, it is possible to obtain display with high contrast and good visibility.

Moreover, a concavo-convex configuration contributing a light scattering function to the variable reflectance mirror 50 may be applied to the variable reflectance mirror 60 of the following Embodiment 3.

### Embodiment 3

Below, still another embodiment according to the present invention will be described. Moreover, for convenience of description, members having the same function as in the diagrams described by the embodiments have the same reference numerals applied thereto and description thereof will not be made.

In the present embodiment, a variable reflectance mirror functioning as a wire grid polarizer will be described. In a liquid crystal display panel including such as variable reflectance mirror, it is possible to make the ranges of the voltage driving the liquid crystal layer the same in the reflective-type display and the transmissive-type display, and the superior effects described below are exhibited. The effect which is similarly obtained in a liquid crystal display panel including an in-cell polarization plate has been previously described.

(Configuration of Variable Reflectance Mirror)

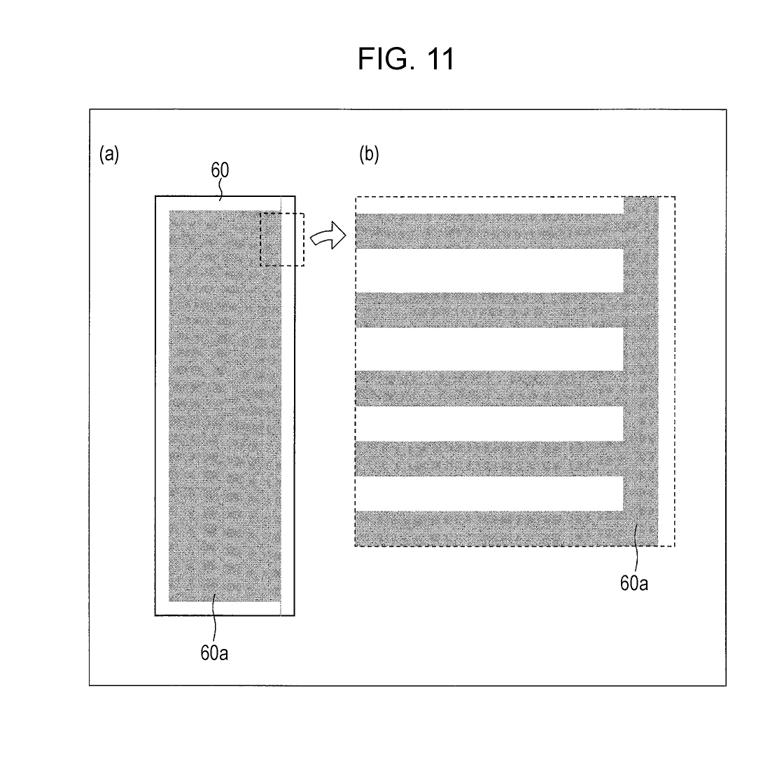

FIG. 11(a) is an explanatory diagram schematically showing a configuration of a variable reflectance mirror 60 functioning as a wire grid polarizer. FIG. 11(b) is an explanatory diagram showing an enlarged portion of the configuration in FIG. 11(a). Moreover, FIG. 11(a) shows a configuration of a variable reflectance mirror 60 in one pixel in plan view.

As a laminated configuration of the variable reflectance mirror 60, it is possible to use either of the laminated configurations of the variable reflectance mirror 5 shown in FIGS. 8 and 9.

The light modulating mirror layer 60a of the variable reflectance mirror 60 corresponding to the light modulating mirror layer 5a provided on the variable reflectance mirror 5 is configured as a collection of a plurality of lines, as shown in FIG. 11(b), in other words, in a comb-like shape. The plurality of lines are parallel to the reference direction (0), and the pitch between lines is set to 100 nm to 120 nm, for example.

For each pixel, the light modulating mirror layer 5a configured in a line shape as in FIG. 11(b) is electrically continuous with the light modulating mirror layer 5a of neighboring pixels. Moreover, the light modulating mirror layer 5a may be made independent per pixel or per predetermined area (plurality of pixels) without being electrically continuous. However, in this case, because each light modulating mirror layer 5a is controlled by a TFT element or the like, the panel configuration becomes complicated.

(Method of Manufacturing Variable Reflectance Mirror)

In order to form the light modulating mirror layer 60a into a comb-like shape, for example, a photoresist is coated and dried on an Mg alloy layer configuring the light modulating mirror layer 60. Thereafter, the photoresist is exposed by a KrF excimer laser with a wavelength of 248 nm, an ArF excimer laser with a wavelength of 193 nm or the like, and a comb-like pattern is formed. Subsequently, the Mg alloy layer is etched using a photoresist mask formed in a comb-like shape. Finally, it is possible to obtain the light modulating mirror layer 60a by removing the photoresist.

### Form Example 6 of Liquid Crystal Display Panel Including Variable Reflectance Mirror 60

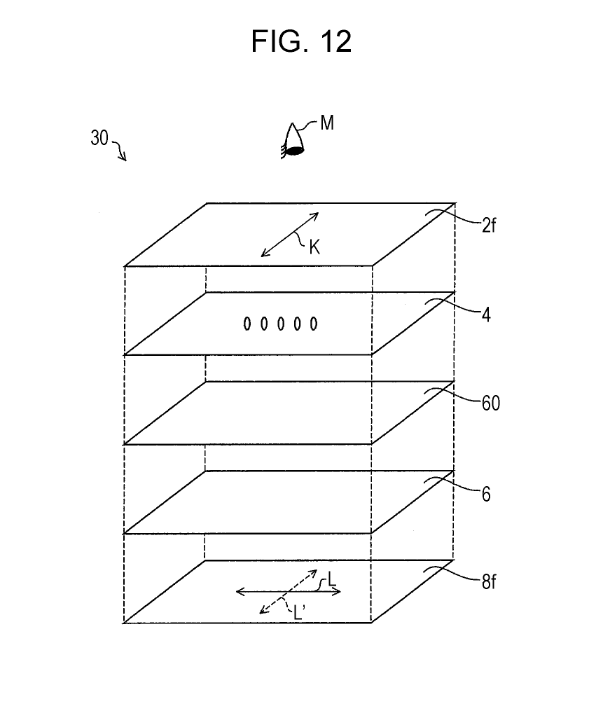

Next, a configuration example of a reflective and transmissive NB mode liquid crystal display panel 30 including the variable reflectance mirror 60 will be described with reference to FIG. 12. FIG. 12 is a diagram schematically describing a configuration of a liquid crystal display panel 30 including the variable reflectance mirror 60.

As shown in FIG. 12, the liquid crystal display panel 30 includes (t) a polarization plate 2f (sixth polarization plate), (u) a liquid crystal layer 4 expressing λ/2 retardation such that a polarization state is changed due to voltage application in a bright state while liquid crystal molecules maintain an initial alignment state in a dark state, (v) a variable reflectance mirror 60 in which a mirror layer is formed as a collection of a plurality of lines parallel in the reference direction, (w) the CF layer 6, (x) a polarization plate 8f (seventh polarization plate) in which the transmission axis L is set to be orthogonal with respect to the transmission axis K of the polarization plate 2f, in this order from the observer M side (display surface side), as optically functional layers.

Moreover, as a liquid crystal layer 4 satisfying the provision of (u), it is possible to use a VA mode liquid crystal layer configured by an n-type liquid crystal vertically aligned during non-application of a voltage. In the bright state, a voltage is applied to the liquid crystal layer 4 such that the liquid crystal layer 4 expresses λ/2 retardation. In this case, it is possible to employ a known method such as forming a rib on the inner face of the substrates interposing the liquid crystal layer 4, or regulating the alignment direction of the liquid crystal molecules through patterning of the electrode or an alignment film. In so doing, the liquid crystal molecules are inclined according to the strength of the electric file such that the λ/2 slow axis has an angle of 45 degrees or −45 degrees with respect to the transmission axis of the polarization plate 2f.

Furthermore, as other liquid crystal layers 4 satisfying the provision of (u), it is possible to use an IPS mode liquid crystal layer horizontally aligned following the reference direction (0) in the dark state (state of non-application of a voltage, initial state) and horizontally aligned to 45 degrees or −45 degrees through application of a voltage in the bright state.

The transmission axis K of the polarization plate 2f is set to be orthogonal to the reference direction (0). In this case, if the settings of the azimuth angle disclosed in (t) to (x) are rewritten according to the above-described denotation, the optical configuration of the reflective and transmissive NB mode liquid crystal display panel 30 may be simply described as polarization plate 2f (90)/liquid crystal layer 4/variable reflectance mirror 60 (90)/CF layer 6/polarization plate 8f (0). Here, the (90) applied to the variable reflectance mirror 60 represents the direction of the transmission axis when the variable reflectance mirror 60 functions as a wire grid polarizer.

(Operation of Liquid Crystal Display Panel 30/NB Mode Reflective-Type Display)

Firstly, a case where the liquid crystal display panel 30 performs NB mode reflective-type display, the reflectance of the variable reflectance mirror 60 is set to be in a high state. Thereby, the variable reflectance mirror 60 functions as a wire grid polarizer.

Next, in setting display to the dark state, a voltage (Vo) applied to the liquid crystal layer 4 is set to a threshold voltage or lower. As a result, the VA mode or IPS mode liquid crystal layer 4 maintains the initial alignment state. Meanwhile, in setting the display to the bright state, in the case of VA mode, a voltage (Ve) is applied to the liquid crystal layer 4 such that the liquid crystal layer 4 expresses λ/2 retardation. In addition, in the case of IPS mode, a voltage (Vf) is applied to the liquid crystal layer 4 such that the director of the liquid crystal layer 4 having λ/2 retardation becomes 45 degrees with respect to the reference direction.

In the dark state, the linearly polarized light (90) passing through the polarization plate 2f (90) is incident on the liquid crystal layer 4, passes therethrough with the polarization state of the linearly polarized light (90) held as is, and reaches the variable reflectance mirror 60 (90). The variable reflectance mirror 60 (90) allows linearly polarized light (90) to pass through, and functions as a wire grip polarizer reflecting linearly polarized light (0).

Accordingly, the linearly polarized light (90) passes through the variable reflectance mirror 60 (90) and is absorbed by the polarization plate 8f (0). As a result, a dark state is displayed.

Meanwhile, in the bright state, because the liquid crystal layer 4 is controlled by application of the voltage Ve or Vf so as to express λ/2 retardation, linearly polarized light (90) passing through the polarization plate 2f (90) is converted to linearly polarized light (0) by passing through the liquid crystal layer 4.

The linearly polarized light (0) is reflected by the variable reflectance mirror 60 (90) functioning as a wire grid polarizer.

The reflected linearly polarized light (0) is converted to linearly polarized light (90) through returning back through the liquid crystal layer 4. Since the linearly polarized light (90) is transmitted through the polarization plate 2f (90), a bright state is displayed.

(Operation of Liquid Crystal Display Panel 30/NB Mode Transmissive-Type Display)

Next, in a case where the liquid crystal display panel 30 performs NB mode transmissive-type display, the reflectance of the variable reflectance mirror 60 is set to be in a low state. As a result, the variable reflectance mirror 60 does not exhibit a function as a wire grid polarizer. Control of the alignment state of the liquid crystal layer 4 according to display of the dark state or the bright state is the same as control in the reflective-type display.

In the dark state, a voltage (Vo) applied to the liquid crystal layer 4 is set to a threshold voltage or lower. The light emitted from the backlight 9 (FIG. 1(b)) becomes linear polarized light (0) due to the polarization plate 8f (0), and passes through the CF layer 6. The linearly polarized light (0) passes through the variable reflectance mirror 60, is incident on the liquid crystal layer 4, and passes through the liquid crystal layer 4 controlled to the initial alignment state with the polarization state held as is.

As a result, because the linearly polarized light (0) is absorbed by the polarization plate 2f (90), the dark state is displayed.

Meanwhile, in the bright state, the linearly polarized light (0) passing through the variable reflectance mirror 60 similarly to above is incident on the liquid crystal layer 4. Since the liquid crystal layer 4 is controlled by application of the voltage Ve or Vf so as to express λ/2 retardation, the linearly polarized light (0) is converted to linearly polarized light (90) by passing through the liquid crystal layer 4.

As a result, because the linearly polarized light (90) is able to pass through the polarization plate 2f (90), the bright state is displayed.

### Modification Example of Form Example 6

### Reflective NB/Transmissive NW Mode

Next, a case where a reflective NB/transmissive NW mode is applied to a liquid crystal display panel 30 including the variable reflectance mirror 60 will be described.

In this case, as shown by the transmission axis L′ of the polarization plate 8f (seventh polarization plate) in FIG. 12 by both dashed-line arrows, the transmission axis L′ may be only made orthogonal with respect to the transmission axis L in the reflective and transmissive NB mode.

Accordingly, the optical configuration of the reflective NB/transmissive NW mode liquid crystal display panel 30 may be simply described as polarization plate 2f (90)/liquid crystal layer 4/variable reflectance mirror 60 (90)/CF layer 6/polarization plate 8f (90).

### Operation of Modification Example of Form Example 6/NW Mode Transmissive-Type Display

Since the content of the operation in which the liquid crystal display panel 30 performs NB mode reflective-type display was previously described, the operation thereof will be simply described concentrating on the transmissive NW mode.

In the transmissive NW mode, the reflectance of the variable reflectance mirror 60 is set to be in a low state. Then, differently from the transmissive NB mode, when display is set to be in a bright state, the voltage applied to the liquid crystal layer 4 is set to a threshold voltage or lower. Meanwhile, when display is set the dark state, the liquid crystal layer 4 is controlled by application of the voltage Ve or of so as to express λ/2 retardation.

In the bright state, a voltage (Vo) applied to the liquid crystal layer 4 is set to a threshold voltage or lower. The light emitted from the backlight 9 (FIG. 1(b)) becomes linear polarized light (90) due to the polarization plate 8f (90), and passes through the CF layer 6. The linearly polarized light (90) passes through the variable reflectance mirror 60, is incident on the liquid crystal layer 4, and passes through the liquid crystal layer 4 controlled to the initial alignment state with the polarization state held as is. As a result, because the linearly polarized light (90) passes through the polarization plate 2f (90), the bright state is displayed.

Meanwhile, in the dark state, the linearly polarized light (90) passing through the variable reflectance mirror 60 similarly to above is incident on the liquid crystal layer 4. Since the liquid crystal layer 4 is controlled by application of the voltage Ve or of so as to express λ/2 retardation, the linearly polarized light (90) is converted to linearly polarized light (0) by passing through the liquid crystal layer 4. As a result, because the linearly polarized light (0) is absorbed by the polarization plate 2f (90), the dark state is displayed.

In this way, in the liquid crystal display panel 30, it is possible to make the settings (voltage range) of the voltage driving the liquid crystal layer 4 according to the dark state and the bright state identical in both of the reflective-type display and the transmissive-type display. As a result, it is possible for the design of the cell thickness to be optimized for both of the reflective-type display and the transmissive-type display at the same time. In other words, it is possible to make design of the optimal cell thickness or the like shared in the reflective-type display and the transmissive-type display, and possible to achieve a simplification of the design.

Moreover, the configuration of FIG. 12 including the variable reflectance mirror 60 becomes a simple configuration compared to the configurations of FIG. 3 to FIG. 6 and the configuration of FIG. 12 by not including two λ/4 retardation plates. In addition, by not including the two λ/4 retardation plates, the liquid crystal display panel 30 is able to provide a brighter transmissive-type display than the liquid crystal display panel 1.

In the liquid crystal display panel according to the present invention, (e) a first polarization plate; (f) a first λ/4 retardation plate in which an azimuth angle of a slow axis is set to 45 degrees with respect to a direction parallel to a transmission axis of the first polarization plate; (g) the liquid crystal layer; (h) the variable reflectance layer; (i) the color filter layer; (j) a second λ/4 retardation plate in which a slow axis is set to be orthogonal or parallel to the slow axis of the first λ/4 retardation plate, and (k) a second polarization plate in which a transmission axis is set to be orthogonal to a transmission axis of the first polarization plate in a case where the respective slow axes of the first and second λ/4 retardation plates are orthogonal, and the transmission axis is set to be parallel to the transmission axis of the first polarization plate in a case where the respective slow axes of the first and second λ/4 retardation plates are parallel; are arranged in the above order from an observer side, and (l) the liquid crystal layer is configured by vertically-aligned n-type liquid crystal, and both of the reflective-type display and the transmissive-type display are operated in the normally black mode.

According to the above configuration, it is possible to provide vertically aligned (Vertical Alignment; VA) liquid crystal display panel that can perform satisfactory reflective-type display and satisfactory transmissive-type display.

Moreover, the optically detailed description is made with the items of the embodiments; however, the liquid crystal display panel is compatible with both of the reflective-type display and the transmissive-type display by controlling the voltage applied to the liquid crystal layer and changing the retardation of the liquid crystal layer.

In addition, in the second polarization plate described as the configuration (k), in a case where the respective slow axes of the first and second λ/4 retardation plates are orthogonal, the transmission axis is set parallel to the transmission axis of the first polarization plate, and in a case where the respective slow axes of the first and second λ/4 retardation plate are parallel, the transmission axis is set to be orthogonal to the transmission axis of the first polarization plate, it is possible to provide liquid crystal display panel in which the reflective-type display is operated in the normally black mode and the transmissive-type display is operated in the normally white mode.

In the liquid crystal display panel according to the present invention, (m) a third polarization plate in which the transmission axis is set to be orthogonal to a reference direction set in a plane parallel to the display surface; (n) the liquid crystal layer; (o) a third λ/4 retardation plate in which an azimuth angle of a slow axis is set to 45 degrees with respect to the reference direction; (p) the variable reflectance layer; (q) the color filter layer; (r) a fourth λ/4 retardation plate in which a slow axis is set to be orthogonal or parallel with respect to the slow axis of the third λ/4 retardation plate, and (s) a fourth polarization plate in which the transmission axis is set to be orthogonal to the transmission axis of the third polarization plate in a case where the respective slow axes of the third and fourth λ/4 retardation plates are orthogonal, and the transmission axis is set to be parallel to the transmission axis of the third polarization plate in a case where the respective slow axes of the third and fourth λ/4 retardation plates are parallel are arranged in the above order from an observer side, and (t) the liquid crystal layer is configured by a p-type liquid crystal horizontally aligned so as to be parallel or orthogonal to the reference direction and having λ/2 retardation, and both of the reflective-type display and the transmissive-type display are operated in the normally black mode.

According to the above configuration, it is possible to provide an In-Plane-Switching (IPS) mode liquid crystal display panel able to perform satisfactory reflective-type display and satisfactory transmissive-type display.

Moreover, the optically detailed description is made with the items of the embodiments; however, the liquid crystal display panel is compatible with both of the reflective-type display and the transmissive-type display by controlling the voltage applied to the liquid crystal layer and changing the azimuth angle of the liquid crystal molecules.

In addition, in the fourth polarization plate described as the configuration (s), in a case where the respective slow axes of the third and fourth λ/4 retardation plates are orthogonal, the transmission axis is set parallel to the transmission axis of the third polarization plate, and in a case where the respective slow axes of the third and fourth λ/4 retardation plate are parallel, the transmission axis is set to be orthogonal to the transmission axis of the third polarization plate, it is possible to provide liquid crystal display panel in which the reflective-type display is operated in the normally black mode and the transmissive-type display is operated in the normally white mode.

In the liquid crystal display panel according to the present invention, (u) a fifth polarization plate; (v) the liquid crystal layer; (w) an in-cell type polarization plate in which a transmission axis is set to be orthogonal with respect to a transmission axis of the fifth polarization plate; (x) the variable reflectance layer; and (y) the color filter layer are arranged in the above order from an observer side, and (z) the liquid crystal layer has λ/2 retardation such that a polarization state is changed due to voltage application in a bright state while liquid crystal molecules maintain an initial alignment state in a dark state, and both of the reflective-type display and the transmissive-type display are operated in the normally black mode.

According to the above configuration, it is possible to provide a liquid crystal display panel able to perform satisfactory reflective-type display and satisfactory transmissive-type display, even with a configuration using an in-cell polarization plate.

As the liquid crystal layer stipulated in (z), it is possible to employ a VA mode liquid crystal layer configured by a vertically aligned n-type liquid crystal, or an IPS mode liquid crystal layer configured by a p-type liquid crystal horizontally aligned so as to be parallel or orthogonal to the reference direction and having λ/2 retardation.

Moreover, the optically detailed description is made with the items of the embodiments; however, the liquid crystal display panel is compatible with both of the reflective-type display and the transmissive-type display by changing the reflectance of the variable reflectance layer while making the retardation of the liquid crystal layer the same in the reflective-type display and the transmissive-type display.

In addition, in the configuration using the in-cell polarization plate, because it is possible to make the setting of the voltage applied to the liquid crystal layer the same in the reflective-type display and the transmissive-type display, it is possible for the design of the cell thickness to be optimized for both of the reflective-type display and the transmissive-type display at the same time. As a result, it is possible to achieve a simplification of the design of the liquid crystal display panel.

Moreover, in the in-cell polarization plate described as the configuration (w), if the transmission axis is set to be parallel with respect to the transmission axis of the fifth polarization plate, it is possible to provide a liquid crystal display panel in which both of the reflective-type display and the transmissive-type display are operated in the normally white mode.

In the liquid crystal display panel according to the present invention, (A) a sixth polarization plate in which the transmission axis is set to be orthogonal to a reference direction set in a plane parallel to the display surface; (B) the liquid crystal layer; (C) the variable reflectance layer; (D) the color filter layer; and (E) a seventh polarization plate in which the transmission axis is set to be orthogonal with respect to the transmission axis of the sixth polarization plate, are arranged in the above order from an observer side, and (F) the variable reflectance layer in which a mirror layer is formed as a collection of a plurality of lines parallel in the reference direction, (G) the liquid crystal layer has λ/2 retardation such that a polarization state is changed due to voltage application in a bright state while liquid crystal molecules maintain an initial alignment state in a dark state, and both of the reflective-type display and the transmissive-type display are operated in the normally black mode.

According to the above configuration, the variable reflectance layer stipulated in (F) functions as a wire grid polarizer in a state with a high reflectance.

As the liquid crystal layer stipulated in (G), it is possible to employ a VA mode liquid crystal layer configured by a vertically aligned n-type liquid crystal, or an IPS mode liquid crystal layer configured by a p-type liquid crystal horizontally aligned so as to be parallel or orthogonal to the reference direction and having λ/2 retardation.

Moreover, in the seventh polarization plate described as the configuration (E), if the transmission axis is set parallel with respect to the transmission axis of the sixth polarization plate, it is possible to provide a liquid crystal display panel in which the reflective-type display is operated in the normally black mode and the transmissive-type display is operated in the normally white mode.

According to the above configuration, it is possible to provide a liquid crystal display panel able to perform satisfactory reflective-type display and satisfactory transmissive-type display.

Moreover, the optically detailed description is made with the items of the embodiments; however, the liquid crystal display panel is compatible with both of the reflective-type display and the transmissive-type display by changing the reflectance of the variable reflectance layer while making the retardation of the liquid crystal layer the same in the reflective-type display and the transmissive-type display.

In addition, in a configuration using the variable reflectance layer functioning as a wire grid polarizer, because it is possible to make the setting of the voltages applied to the liquid crystal layer the same in the reflective-type display and the transmissive-type display, it is possible to optimize at the same time the design of the cell thickness and the like for both of the reflective-type display and the transmissive-type display. As a result, it is possible to achieve a simplification of the design of the liquid crystal display panel.

A reflective surface of the variable reflectance layer has a light scattering function based on a plurality of convexities and concavities.

According to the above configuration, since the variable reflectance layer has a light scattering function, it is possible to increase the amount of reflected light in a direction other than the specular reflection direction with respect to the reflective surface. In so doing, it is possible to perform brighter reflective-type display with increased contrast with respect to a direction other than the specular reflection direction with respect to the reflective surface, in other words, reflective display with a wide viewing angle, even without separately providing a scattering film or the like.

In addition, as described above, in the liquid crystal display panel according to the present invention, because the problem of parallax caused by the thickness of the substrate and the polarization plate provided on the rear face side of the opposite side to the display surface of the liquid crystal display panel does not occur, it is possible to provide a reflective-type display with improved display quality through controlling the occurrence of parallax.

The present invention is not limited to the above-described embodiments with various modifications being possible in the range disclosed in the claims, and embodiments obtained by appropriate combination of the technical means disclosed in each of the different embodiments are also included in the technical range of the present invention.

### INDUSTRIAL APPLICABILITY

The present invention may be particularly suitably used in a portable-type display device having a use in which reflective-type display and transmissive-type display are switched between according to the environmental illuminance, such as a portable telephone, PDA, display for a video camera, or a display for a tablet-style personal computer.

### REFERENCE SIGNS LIST

1 liquid crystal display panel
1A liquid crystal display device
2a polarization plate (first polarization plate)
2b λ/4 retardation plate (first λ/4 retardation plate)
2c polarization plate (third polarization plate)
2d λ/4 retardation plate (third λ/4 retardation plate)
2e polarization plate (fifth polarization plate)
2f polarization plate (sixth polarization plate)
4 liquid crystal layer
5 variable reflectance mirror (variable reflectance layer)
6 CF layer (color filter layer)
8 polarization plate
8a λ/4 retardation plate (second λ/4 retardation plate)
8b polarization plate (second polarization plate)
8c λ/4 retardation plate (fourth λ/4 retardation plate)
8d polarization plate (fourth polarization plate)
8e in-cell type polarization plate
8f polarization plate (seventh polarization plate)
9 backlight
20 liquid crystal display panel
30 liquid crystal display panel
50 variable reflectance mirror (variable reflectance layer)
60 variable reflectance mirror (variable reflectance layer)
60a light modulating mirror layer (mirror layer)

1. A liquid crystal display panel comprising:
a liquid crystal layer;
a color filter layer; and
a variable reflectance layer that is arranged between the liquid crystal layer and the color filter layer and changes the reflectance of light by external control,
wherein the liquid crystal display panel switches between transmissive-type display in which a path of light is a path passing through the liquid crystal layer in one direction and reflective-type display in which a path of light is a path in which light directed at the variable reflectance layer from the liquid crystal layer is reflected on the variable reflectance layer according to control of reflectance of the variable reflectance layer.

2. The liquid crystal display panel according to claim 1, wherein
a first polarization plate;
a first λ/4 retardation plate in which an azimuth angle of a slow axis is set to 45 degrees with respect to a direction parallel to a transmission axis of the first polarization plate;
the liquid crystal layer;
the variable reflectance layer;
the color filter layer;
a second λ/4 retardation plate in which a slow axis is set to be orthogonal or parallel to the slow axis of the first λ/4 retardation plate; and
a second polarization plate in which a transmission axis is set to be orthogonal to a transmission axis of the first polarization plate in a case where the respective slow axes of the first and second λ/4 retardation plates are orthogonal, and the transmission axis is set to be parallel to the transmission axis of the first polarization plate in a case where the respective slow axes of the first and second λ/4 retardation plates are parallel
are arranged in the above order from an observer side,
wherein the liquid crystal layer is configured by vertically-aligned n-type liquid crystal, and
wherein both of the reflective-type display and the transmissive-type display are operated in the normally black mode.

3. The liquid crystal display panel according to claim 1, wherein
a third polarization plate in which a transmission axis is set to be orthogonal to a reference direction set in a plane parallel to a display surface;
the liquid crystal layer;
a third λ/4 retardation plate in which an azimuth angle of a slow axis is set to 45 degrees with respect to the reference direction;
the variable reflectance layer;
the color filter layer;
a fourth λ/4 retardation plate in which a slow axis is set to be orthogonal or parallel with respect to the slow axis of the third λ/4 retardation plate; and
a fourth polarization plate in which a transmission axis is set to be orthogonal to the transmission axis of the third polarization plate in a case where the respective slow axes of the third and fourth λ/4 retardation plates are orthogonal, and the transmission axis is set to be parallel to the transmission axis of the third polarization plate in a case where the respective slow axes of the third and fourth λ/4 retardation plates are parallel
are arranged in the above order from an observer side,
wherein the liquid crystal layer is configured by a p-type liquid crystal horizontally aligned so as to be parallel or orthogonal to the reference direction and having λ/2 retardation, and
wherein both of the reflective-type display and the transmissive-type display are operated in the normally black mode.

4. The liquid crystal display panel according to claim 1, wherein
a first polarization plate;
a first λ/4 retardation plate in which an azimuth angle of a slow axis is set to 45 degrees with respect to a direction parallel to a transmission axis of the first polarization plate;
the liquid crystal layer;
the variable reflectance layer;
the color filter layer;
a second λ/4 retardation plate in which a slow axis is set to be orthogonal or parallel to the slow axis of the first λ/4 retardation plate; and
a second polarization plate in which a transmission axis is set to parallel to the transmission axis of the first polarization plate in a case where the respective slow axes of the first and second λ/4 retardation plates are orthogonal, and the transmission axis is set to be orthogonal to the transmission axis of the first polarization plate in a case where the respective slow axes of the first and second λ/4 retardation plates are parallel
are arranged in the above order from an observer side,
wherein the liquid crystal layer is configured by vertically aligned n-type liquid crystal, and
wherein the reflective-type display is operated in the normally black mode and the transmissive-display is operated in a normally white mode.

5. The liquid crystal display panel according to claim 1, wherein
a third polarization plate in which a transmission axis is set to be orthogonal to a reference direction set in a plane parallel to the display surface;
the liquid crystal layer;
a third λ/4 retardation plate in which an azimuth angle of a slow axis is set to 45 degrees with respect to the reference direction;
the variable reflectance layer;
the color filter layer;
a fourth λ/4 retardation plate in which a slow axis is set to be orthogonal or parallel with respect to the slow axis of the third λ/4 retardation plate, and
a fourth polarization plate in which a transmission axis is set to be parallel with respect to the transmission axis of the third polarization plate in a case where the respective slow axes of the third and fourth λ/4 retardation plates are orthogonal, and the transmission axis is set to be orthogonal to the transmission axis of the third polarization plate in a case where the respective slow axes of the third and fourth λ/4 retardation plates are parallel
are arranged in the above order from an observer side,
wherein the liquid crystal layer is configured by a p-type liquid crystal horizontally aligned so as to be parallel or orthogonal to the reference direction and having λ/2 retardation, and
wherein the reflective-type display is operated in the normally black mode and the transmissive-type display is operated in the normally white mode.

6. The liquid crystal display panel according to claim 1, wherein
a fifth polarization plate;
the liquid crystal layer;
an in-cell type polarization plate in which a transmission axis is set to be orthogonal with respect to a transmission axis of the fifth polarization plate;
the variable reflectance layer; and
the color filter layer
are arranged in the above order from an observer side,
wherein the liquid crystal layer has λ/2 retardation such that a polarization state is changed due to voltage application in a bright state while liquid crystal molecules maintain an initial alignment state in a dark state, and
wherein both of the reflective-type display and the transmissive-type display are operated in the normally black mode.

7. The liquid crystal display panel according to claim 1, wherein
a fifth polarization plate;
the liquid crystal layer;
an in-cell type polarization plate in which a transmission axis is set to be parallel with respect to a transmission axis of the fifth polarization plate;
the variable reflectance layer; and
the color filter layer
are arranged in the above order from an observer side,
wherein the liquid crystal layer has λ/2 retardation such that a polarization state is changed due to voltage application in a bright state while liquid crystal molecules maintain an initial alignment state in a dark state, and
wherein both of the reflective-type display and the transmissive-type display are operated in the normally white mode.

8. The liquid crystal display panel according to claim 1, wherein
a sixth polarization plate in which a transmission axis is set to be orthogonal to a reference direction set in a plane parallel to a display surface;
the liquid crystal layer;
the variable reflectance layer;
the color filter layer; and
a seventh polarization plate in which a transmission axis is set to be orthogonal with respect to a transmission axis of the sixth polarization plate
are arranged in the above order from an observer side,
wherein the variable reflectance layer is a variable reflectance layer in which a mirror layer is formed as a collection of a plurality of lines parallel in the reference direction,
wherein the liquid crystal layer has λ/2 retardation such that a polarization state is changed due to voltage application in a bright state while liquid crystal molecules maintain an initial alignment state in a dark state, and
wherein both of the reflective-type display and the transmissive-type display are operated in the normally black mode.

9. The liquid crystal display panel according to claim 1, wherein
a sixth polarization plate in which a transmission axis is set to be orthogonal to a reference direction set in a plane parallel to a display surface;
the liquid crystal layer;
the variable reflectance layer;
the color filter layer; and
a seventh polarization plate in which the transmission axis is set to be parallel with respect to the transmission axis of the sixth polarization plate
are arranged in the above order from an observer side,
wherein the variable reflectance layer is a variable reflectance layer in which a mirror layer is formed as a collection of a plurality of lines parallel in the reference direction,
wherein the liquid crystal layer has λ/2 retardation such that a polarization state is changed due to voltage application in a bright state while liquid crystal molecules maintain an initial alignment state in a dark state, and
wherein the reflective-type display is operated in a normally black mode and the transmissive-type display is operated in the normally white mode.

10. The liquid crystal display panel according to claim 1, wherein a reflective surface of the variable reflectance layer has a light scattering function based on a plurality of irregularities.

11. A liquid crystal display device comprising:
the liquid crystal display panel according to claim 1, and
a light source for transmissive-type display.
